(19) United States
(12) Patent Application Publication
(10) Pub. No.: US 2025/0273451 A1
(43) Pub. Date: Aug. 28, 2025

(54) SYSTEMS AND METHODS FOR MASS SPECTROMETRY

(71) Applicant: Peninsula Technologies, LLC, Wilmington, DE (US)

(72) Inventors: Satendra PRASAD, Wilmington, DE (US); Viatcheslav v. KOVTOUN, Wilmington, DE (US); Gordon A. ANDERSON, Wilmington, DE (US); Mihajlo DZEPINA, Wilmington, DE (US); Sidney E. BUTTRILL, JR., Wilmington, DE (US)

(21) Appl. No.: 19/195,453

(22) Filed: Apr. 30, 2025

Related U.S. Application Data
(63) Continuation of application No. PCT/US2023/078724, filed on Nov. 3, 2023.
(60) Provisional application No. 63/382,481, filed on Nov. 4, 2022.
(60) Provisional application No. 63/383,685, filed on Nov. 14, 2022.
(60) Provisional application No. 63/486,905, filed on Feb. 24, 2023.

(51) Int. Cl. H01J 49/06; G01N 27/623; H01J 49/24

(52) U.S. Cl. CPC H01J 49/063; G01N 27/623; H01J 49/24

(57) ABSTRACT

Described herein are mass spectrometers, ion manifolds, and analytical methods for high-duty cycle, tandem mass spectrometery.

### CROSS-REFERENCE

This application is a continuation of International Application No. PCT/US2023/078724, filed Nov. 3, 2023, which claims the benefit of U.S. Provisional Application No. 63/382,481, filed Nov. 4, 2022, U.S. Provisional Application No. 63/383,685, filed Nov. 14, 2022, and U.S. Provisional Application No. 63/486,905, filed Feb. 24, 2023, each of which is incorporated herein by reference in their entirety.

### BACKGROUND

Over the past few decades, mass spectrometers and analysis methods based on mass spectrometry have seen substantial improvements in instrument sensitivity and resolution, which has expanded their application into nearly every branch of physical science. There are, however, problems in these fields that remain unaddressed. Tandem mass spectrometers (MS/MS), particularly those with high mass resolving powers, suffer from substantial losses of ion flux between MS1 and MS2, caused by a mismatch in ion transmission efficiency due to coupling very fast isolation in MS1 with very slow spectral scanning in MS2. Accordingly, improved mass spectrometers and mass spectrometry-based methods of analysis are needed to mitigate these losses.

### SUMMARY

In one aspect, described herein are ion manifolds, mass spectrometers comprising ion manifolds, and mass spectrometry-based analysis methods that allow for parallel analysis of a single ion flux by a plurality of mass analyzers.

In one aspect, described herein, are multiplexed methods of acquiring tandem mass spectra of a sample. In some embodiments, the method comprises ionizing the sample using an ion source to produce gas-phase ions. In some embodiments, the method comprises introducing the gas-phase ions into a mass spectrometer. In some embodiments, the method comprises selecting a first mass isolation window of a first one of at least two mass analyzers corresponding to a first one of a plurality of ion manifold outlets of the mass spectrometer.

In some embodiments, the method comprises selecting a second mass isolation window of a second one of at least two mass analyzers corresponding to a second one of a plurality of ion manifold outlets of the mass spectrometer. In some embodiments, the method comprises acquiring mass spectra of both the first and second mass isolation windows using the at least two mass analyzers.

In some embodiments, the methods comprise selecting a third mass isolation window of a third one of the at least two mass analyzers corresponding to a third one of the plurality of ion manifold outlets; and acquiring mass spectra of the first, second, and third mass isolation windows using the at least two mass analyzers. In some embodiments, the methods comprise selecting a fourth mass isolation window of a fourth one of the at least two mass analyzers corresponding to a fourth one of the plurality of ion manifold outlets; and acquiring mass spectra of the first, second, third, and fourth mass isolation windows using the at least two mass analyzers.

In some embodiments, the methods comprise selecting a first upstream mass window of the first mass filter and/or a collision energy of the first collision cell. In some embodiments, the methods comprise selecting a second mass window of the second upstream mass filter and/or a collision energy of the second collision cell corresponding. In some embodiments, the methods comprise acquiring mass spectra of both the first and second mass windows and/or of the first and second collision energies using the at least one mass analyzer.

In some embodiments, the methods further comprise selecting an ion injection timing sequence during which a plurality of outlets of the ion manifold are to be selected using the ion manifold selector. In some embodiments, the sample is a biological sample. In some embodiments, the sample is a proteomics sample. In some embodiments, the sample comprises at least 100 different proteins. In some embodiments, the sample is obtained from a chromatograph separation prior to analysis. In some embodiments, at least 1000 peptides (e.g. at least 5000, at least 10,000, or at least 20,000) are identified in the sample using the methods and/or mass spectrometers of this disclosure.

In some embodiments, tandem mass spectra are acquired in DIA mode. In some embodiments, tandem mass spectra are acquired in DDA mode. In some embodiments, the tandem mass spectra are acquired in pseudo-DDA mode. In some embodiments, the MSI mass window is less than about 4 amu (e.g. 2, 1, or 0.5 amu). In some embodiments, the MSI mass window is less than about 10 amu. In some embodiments, the MS1 mass window is less than about 5 amu. In some embodiments, the MS1 mass window is less than about 4 amu. In some embodiments, the MS2 resolving power is at least 10,000 (e.g. at least 10,000, at least 30,000, at least 50,000, at least 300,000, or at least 1,000,000). In some embodiments, the MS2 resolving power is no more than 1,000,000 (e.g. no more than 500,000, no more than 300,000, no more than 100,000, no more than 50,000, or no more than 30,000).

In another aspect, described herein are tandem mass spectrometers. In some embodiments, the mass spectrometers comprise a vacuum system, an ion inlet, operably coupled to the vacuum system, and a first set of ion optics arranged within the vacuum system and configured to guide ions from the ion inlet toward an ion manifold within the vacuum system. In some embodiments, the tandem mass spectrometers comprise a plurality of mass analyzers. In some embodiments, the tandem mass spectrometers comprise at least 3 mass analyzers. In some embodiments, the tandem mass spectrometers comprise at least 4 mass analyzers. In some embodiments, at least two mass analyzers are disposed in a single chamber of the vacuum system.

In some embodiments, a first set of ion optics comprises a field asymmetric waveform ion mobility spectrometry device and a traveling wave ion mobility spectrometry device (TWIMS) or a trapped ion mobility spectrometry device (TIMS). In some embodiments, the field asymmetric waveform ion mobility spectrometry device is upstream of the traveling wave ion mobility spectrometry device (TWIMS) or the trapped ion mobility spectrometry device (TIMS). In some embodiments, the field asymmetric waveform ion mobility spectrometry device is designed to operate at less than atmospheric pressure (e.g., less than 100 torr, less than 50 torr, less than 20 torr, less than 10 torr, or less than 5 torr). In some embodiments, the field asymmetric waveform ion mobility spectrometry device is configured to preferentially remove ions with a +1 net charge. In some embodiments, the second set of ion optics further comprising at least one collision cell and at least one upstream mass filter corresponding to each of the at least one mass analyzers. In some embodiments, the second set of ion optics comprises a second collision cell and/or a second mass filter corresponding to each of the at least one mass analyzers.

In another aspect, described herein are ions manifolds for directing an ion flux to a plurality of mass analyzers. In some embodiments, the ion manifolds comprise an ion manifold inlet and a plurality of ion manifold outlets. In some embodiments, the ion manifolds comprise at least one ion outlet selector. In some embodiments, the at least one ion outlet selector is configurable to direct an ion flux entering through the ion manifold inlet to one or more selected outlets of the plurality of ion manifold outlets.

In some embodiments, the ion outlet selector comprises at least one quadrupole disposed between the ion manifold inlet and the plurality of ion manifold outlets. In some embodiments, the at least one quadrupole is configurable to guide ions toward a selected one of the plurality of ion manifold outlets. In some embodiments, the ion outlet selector comprises a plurality of RF and/or DC ion guide lenses.

In some embodiments, the ion manifold directs the ion flux from the ion manifold inlet, to two or more ion manifold outlets simultaneously, or near simultaneously (e.g. within seconds or milliseconds). In some embodiments, ion optics comprise an ion funnel, a plurality of ion lenses, and one or more quadrupole ion guides.

In some embodiments, the vacuum system comprises a plurality of vacuum chambers. In some embodiments, the at least two mass analyzers are disposed in separate chambers of the vacuum system. In some embodiments, the plurality of vacuum chambers are differentially pumped such that each chamber has a pressure different from the pressure in at least one of the other chambers. In some embodiments, a pressure in the ion manifold during operation is less than about 10 μTorr.

In some embodiments, the vacuum system comprises a plurality of vacuum chambers upstream of the ion manifold inlet. In some embodiments, the plurality of ion manifold outlets comprise two ion manifold outlets. In some embodiments, the plurality of ion manifold outlets comprise at least three (e.g. at least 3, 4, or 5) ion manifold outlets. In some embodiments, the at least two mass analyzers comprise at least three (e.g. at least 3, 4, or 5) mass analyzers. In some embodiments, each of the at least two mass analyzers are operated at the same or substantially the same pressure. In some embodiments, substantially the same pressure denotes a pressure difference between vacuum chambers of each mass of no more than 30%, 20%, 10%, or 5%.

In some embodiments, the at least two mass analyzers share common control electronics. In some embodiments, the common control electronics are used for control of ion manipulation, RF, and/or DC fields of the mass analyzers. In some embodiments, the at least one quadrupole disposed between the ion manifold inlet and the plurality of ion manifold outlets comprises a linear quadrupole. In some embodiments, the axis of the linear quadrupole is substantially orthogonal to the ion manifold inlet axis.

In some embodiments, each of the at least two mass analyzers is independently selected from a linear quadrupole ion trap mass analyzer, a three dimensional quadrupole ion trap mass analyzer, an electrostatic axially harmonic orbital trapping mass analyzer, a time-of-flight mass analyzer, a distance-of-flight mass analyzer, a magnetic sector mass analyzer, a Fourier-transform ion cyclotron residence (FT-ICR) mass analyzer, and a linear quadrupole mass analyzer.

In some embodiments, each of the at least two mass analyzers are electrostatic axially harmonic orbital trapping, FT-ICR, or time-of-flight mass analyzers. In some embodiments, each of the at least two mass analyzers are electrostatic axially harmonic orbital trapping mass analyzers. In some embodiments, each of the at least two mass analyzers are FT-ICR mass analyzers. In some embodiments, each of the at least two mass analyzers are linear quadrupole ion trap mass analyzers. In some embodiments, each of the at least two mass analyzers are time-of-flight mass analyzers. In some embodiments, each of the at least two mass analyzers are orthogonal acceleration time-of-flight mass analyzers. In some embodiments, each of the at least two mass analyzers are sector time-of-flight mass analyzers.

In some embodiments, each of the mass analyzers is configured to scan across an independently selected mass range during at least partially overlapping periods of time. In some embodiments, each of the mass analyzers is configured to scan across an independently selected mass range at essentially the same time.

In some embodiments, the second set of ion optics comprises one or more collision activated dissociation cells each disposed between one or more of the ion manifold outlets and one or more of the at least two mass analyzers. In some embodiments, the second set of ion optics comprises one or more quadrupole mass filters each disposed between one or more of the ion manifold outlets and one or more of the at least two mass analyzers. In some embodiments, each of the plurality of ion manifold outlets are gated using a set of stacked lenses corresponding to the individual ion manifold outlet.

In some embodiments, the ion manifold and the at least two mass analyzers comprise at least a minimum number of ion manifold outlets and a minimum number of mass analyzers required to reduce or minimize dead time when sequential ion injections are used to provide near simultaneous mass analysis of the different mass to charge isolation windows.

In some embodiments, the ion source is an atmospheric pressure ion source. In some embodiments, the ion source is electrospray ionization (ESI). In some embodiments, the ion source is a nano-electrospray emitter. In some embodiments, the mass spectra are acquired near simultaneously by sequentially injecting ions into the at least two mass analyzers through the plurality of ion manifold outlets. In some embodiments, the dead time for near simultaneous acquisition by sequential ion injections is essentially zero.

In some embodiments, the methods provided herein can comprise separating a biological sample over time (e.g., by liquid chromatography). In some embodiments, the methods comprise ionizing the biological sample as the biological sample is being separated. In some embodiments, the methods comprise selectively removing singly-charged ions from the gas-phase ions from the separated biological sample. In some embodiments, the selectively removing comprises introducing the gas-phase ions from the separated biological sample into a field asymmetric waveform ion mobility spectrometry device to selectively remove singly-charged ions, wherein the field asymmetric waveform ion mobility spectrometry device is maintained at a pressure below 100 torr. In some embodiments, the methods comprise introducing enriched multiply-charged gas-phase ions from the separated biological sample to a travelling wave ion mobility device to separate the multiply-charged ions based on mobility.

In some embodiments, the methods comprise sequentially introducing windows of ions having different ion mobilities from the travelling wave ion mobility spectrometry device into a collision cell and fragmenting the windows of ions. In some embodiments, the methods comprise sequentially analyzing the different windows of fragmented ions using a time-of-flight mass analyzer, wherein at least 100 different windows corresponding to different ion mobilities are analyzed each second.

In some embodiments, the methods comprise filtering the windows of ions having different ion mobilities to remove ions outside of a window of 10 amu or less, wherein said filtering occurs before the introducing of ions into the collision cell. In some embodiments, the ions having different ion mobilities from the travelling wave ion mobility spectrometry device are not filtered based on m/z before introducing into the collision cell.

In some embodiments, the time-of-flight mass analyzer is a sector time-of-flight mass analyzer. In some embodiments, the time-of-flight mass analyzer is an orthogonal acceleration time-of-flight mass analyzer. In some embodiments, sequentially analyzing the different windows of fragmented ions uses a plurality of time-of-flight mass analyzers. In some embodiments, the field asymmetric waveform ion mobility spectrometry device is maintained at a pressure below 100 torr.

In another aspect described herein are systems comprising a liquid chromatography device configured to separate a biological sample over time. In some embodiments, the systems comprise an electrospray ionization device configured to ionize the biological sample while being separated by the liquid chromatography device. In some embodiments, the systems comprise a field asymmetric waveform ion mobility spectrometry device configured to selectively remove singly-charged gas-phase ions received from the electrospray ionization device. In some embodiments, the systems comprise a travelling wave ion mobility device configured to separate multiply-charged ions received from the field asymmetric waveform ion mobility spectrometry device based on mobility.

In some embodiments, the systems comprise a collision cell configured to fragment ion-mobility-sorted, multiply charged ions received from the travelling wave ion mobility device. In some embodiments, the systems comprise a time-of-flight mass analyzer configured to analyze the fragmented ions from the collisional cell.

In some embodiments, the systems comprise a mass filter configured to filter windows of ions having different ion mobilities from the travelling waive ion mobility device to remove ions outside of a window of 10 amu or less before introduction into the collision cell.

In some embodiments, the systems do not include a mass filter to remove ions received from the travelling wave ion mobility device before introduction into the collision cell. In some embodiments, the time-of-flight mass analyzer is a sector time-of-flight mass analyzer. In some embodiments, the time-of-flight mass analyzer is an orthogonal acceleration time-of-flight mass analyzer. In some embodiments, the systems comprises a plurality of time-of-flight mass analyzers configured. In some embodiments, the field asymmetric waveform ion mobility spectrometry device is configured to remove singly-charged ions at a pressure below 100 torr. In some embodiments, the systems can be configured to perform any of the steps of any of the methods described herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 illustrates an example mass spectrometer comprising an ion manifold and a plurality of mass analyzers as described herein.

FIG. 2 illustrates an example of a substantially orthogonal quadrupole based ion manifold with two ion manifold outlets as described herein.

FIG. 3 illustrates an example of an ion manifold with a large number of outlets depicted as an array, allowing parallel operation of numerous mass analyzers. Each outlet of the plurality of outlets in the example can be used to direct at least a portion of the incoming ion flux to an individual mass analyzer.

FIG. 4 illustrates an example of an interface between an ion optic (such as a square, linear quadrupole) and an ion manifold (such as one utilizing a square, linear, orthogonally positioned quadrupole).

FIG. 5 illustrates an example of an ion manifold with two outlets interfaced to two different ion optics.

FIG. 6 illustrates an example of an ion manifold with four ion manifold outlets. In the example, horizontal quadrupoles are segmented to allow the application of a DC bias voltage. Ion manifolds similar to this example can be constructed by chaining more than two such segments together to extend the number of ion manifold outlets.

FIG. 7 illustrates an example of a compact multi-outlet ion manifold capable of diverting ions to a plurality of manifold outlet ion optics utilizing a quadrupole comprising a continuous structure with a radius at the end.

FIG. 8 illustrates example injection schemes for introducing ions into a plurality of mass analyzers. As seen in the example, scanning more mass spectrometers in parallel allows for reduction or elimination of dead time.

FIG. 9 illustrates a computational multiphysics simulation modeling ion trajectory in an example ion manifold similar to that shown in FIG. 7. This image shows two rods of a total of four rods of a quadrupole and the trajectory of the ions of m/z 600 with a charge of 2+. The voltages are applied such that all the ions are passing through the quadrupole and not going through the extraction outlet which is not selected in this example. This condition is termed here as a pass-through mode.

FIG. 10 illustrates a computational multiphysics simulation modeling ion trajectory in an example ion manifold similar to that shown in FIG. 7 and identical to that shown in FIG. 9. This image shows two quads of the total four quads and the trajectory of the 100 ions of m/z 600 with a charge of 2. Voltages are applied such the all the ions are extracted from the quadrupole device through the illustrated ion manifold outlet. The extraction point of the outlet is a 0.5 mm diameter insertion made on the outer most rod of the ion manifold quadrupole. A negative potential is applied to force the ions out of the quadrupolar electric field and pass through the extraction outlet (which is selected in this illustration).

FIG. 11 illustrates a computational multiphysics simulation modeling ion trajectory in an example ion manifold utilizing a horizontal square quadrupole with side extraction. In this example, an ion manifold outlet is a side of one quadrupole that has circular cut through to extract ions into a side quadrupole. In this illustration voltages are applied to direct ions in the manifold to the selected outlet shown in the illustration.

FIG. 12 illustrates the same computational multiphysics simulation as in FIG. 11, comprising a 3D Side view of an ion beam in the example manifold passing through under “no deflection” condition (wherein voltages are applied to direct ions away from the illustrated ion manifold outlet which is not selected in the illustration).

FIG. 13 illustrates an example workflow for methods and mass spectrometers described herein which utilize a field asymmetric ion mobility spectrometry device, a travelling-wave ion mobility spectrometry device, and a plurality of mass analyzers.

FIG. 14 illustrates an example workflow for methods and mass spectrometers described herein which utilize a field asymmetric ion mobility spectrometry device, a travelling-wave ion mobilty spectrometry device, and a single mass analyzer.

FIG. 15 shows a computer system that is programmed or otherwise configured to implement methods provided herein.

FIG. 16 illustrates an example workflow for methods and mass spectrometers described herein which utilize an ion source 1601, a field asymmetric ion mobility spectrometry device 1602, an ion mobility device 1603 such as a travelling-wave ion mobilty spectrometry device, an optional mass filter 1604, an optional ion steering device 1605, at least one collision cell 1606, and at least one mass analyzer such as a Time-of-flight-mass analyzer 1608.

FIG. 17 illustrates an example diagram of a multichamber ion sampling interface comprising either a reduced-pressure field asymmetric ion mobility spectrometry device (FAIMS) or a quadrupole ion guide in the third chamber 1701. Pressure within the third chamber is controllable by introducing a controlled amount of gas through the gas inlet port 1703. Example dimensions and operating voltage are also illustrated. When a FAIMS device is present, FAIMS can be achieved using a bi-sinusoidal waveform (e.g. Estimate: Vpp 1,000V, CV −60V to 0V, 2 MHz).

FIG. 18 illustrates an example travelling-wave or trapped ion mobility spectrometry device (TWIMS or TIMS) capable of being coupled to a reduced-pressure FAIMS device. Example dimensions and operating voltages are also illustrated for TWIMS.

FIG. 19 illustrates an example curved collision cell which can be coupled to receive ions from a TWIMS or TIMS device.

FIG. 20 illustrates use of two or more collision cells and two or more mass analyzers for methods and mass spectrometers described herein.

FIG. 21 illustrates use of an ion switch to divert ions into one of a plurality of sector time-of-flight mass analyzers.

FIG. 22 illustrates an example ion sampling interface and control module scheme for comprising a reduced pressure FAIMS device and a traveling wave ion mobility spectrometer. Pulse sequences can be generated by RF and/or DC power supplies which provide precise control of timing and/or waveform generation (depicted in the illustration as MIPS-A and MIPS-B). All subsystems can be connected to a control PC via USB or other suitable interface. A host application and control panel can be used for control of subsystems such as the power supplies.

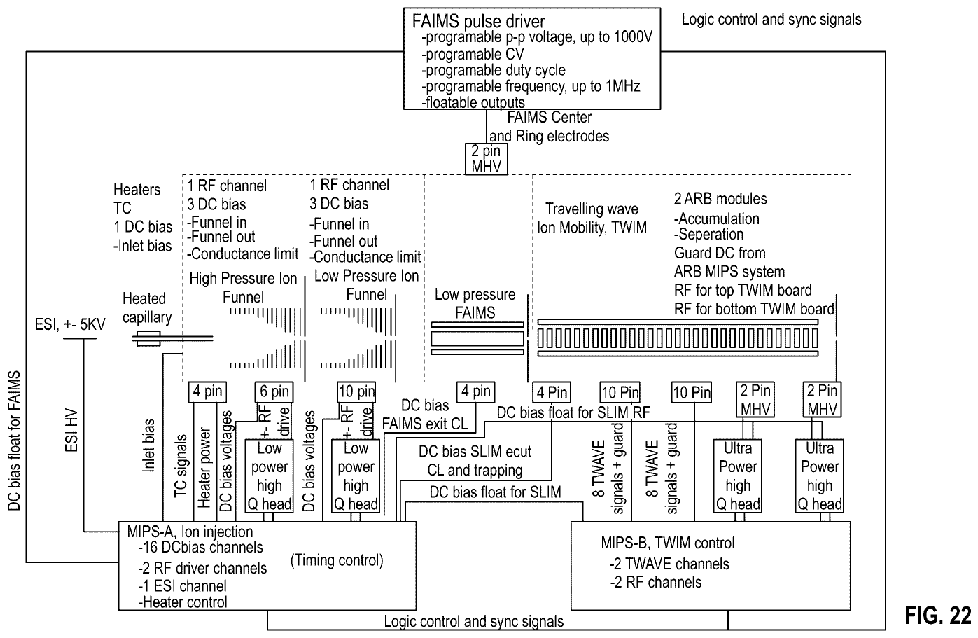

### DETAILED DESCRIPTION

While various embodiments of the disclosure have been shown and described herein, it will be obvious to those skilled in the art that such embodiments are provided by way of example only. Numerous variations, changes, and substitutions can occur to those skilled in the art without departing from the disclosure. It should be understood that various alternatives to the embodiments of the disclosure described herein can be employed. The section headings used herein are for organizational purposes only and are not to be construed as limiting the subject matter described.

### Definitions

Unless defined otherwise, all technical and scientific terms used herein have the same meaning as is commonly understood by one of skill in the art to which this disclosure belongs. All patents and publications referred to herein are incorporated by reference.

As used herein, “near simultaneous” generally refers to events which occur at nearly, but not exactly the same time. Near simultaneous can refer to parallel events which begin at different times (e.g. with start points within seconds or milliseconds of each other) or can refer to sequential events which occur in rapid succession (e.g. where the end of a first event occurs no more than milliseconds or hundreds of milliseconds before the start of a subsequent event). In some embodiments, near simultaneous events may occur within 25 ms, within 10 ms, within 5 ms, or within 2 ms.

As used herein, “dead time” and “dead-time” are used interchangeably and generally refer to a period of time during the operation of a mass spectrometer where one or more mass analyzers are not available to accept ions (such as when scanning an ion trap). Such dead time often causes ions to be diverted to waste.

As used herein, “quadrupole” generally refers to any device or method step relying on a combination of radiofrequency (or near radiofrequency AC) and DC fields to guide or select ions from an ion flux traversing the AC and/or DC fields. Quadrupoles can take a diverse variety of forms, including but not limited to linear true quadrupoles (i.e. with four straight, parallel, guide rods to which the RF and DC are applied), bent or twisted quadrupoles, hexapoles, octopoles, flatapoles, and the like. Quadrupoles can generally be operated as mass to charge ratio filters or selectors, or as broadband ion guides (e.g. in RF only mode). Ion transmission and/or filtering through a quadrupole can generally be described using a Matthieu stability diagram or calculation.

As used herein, “ion optic” generally refers to any device or combination of devices that are capable of directing the path of an ion flux in a controlled manner. Non limiting examples include AC or DC lenses, quadrupoles, collision cells and the like.

As used herein, “mass analyzer” generally refers to a device which is capable of determing a mass to charge ratio and an intensity or a number of counts per second of one or more ions arriving at a detector comprised within the analyzer.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

As used herein, a “feature” identified by mass spectrometry includes a signal at a specific combination of retention time and m/z (mass-to-charge ratio), where each feature has an associated intensity. Some features are further fragmented in a second mass spectrometry analysis (MS2) for identification.

As used herein, the terms “amu”, “atomic mass units”, “m/z”, or “mass-to-charge ratio”, when used as a unit of measurement, are used interchangeably and generally refer to a mass-to-charge ratio in Thompsons (Th).

As used herein, “Biomolecule” can refer to any molecule or biological component that can be produced by, or is present in, a biological organism. Non-limiting examples of biomolecules include proteins (protein corona), polypeptides, oligopeptides, polyketides, polysaccharides, a sugar, a lipid, a lipoprotein, a metabolite, an oligonucleotide, a nucleic acid (DNA, RNA, micro RNA, plasmid, single stranded nucleic acid, double stranded nucleic acid), metabolome, as well as small molecules such as primary metabolites, secondary metabolites, and other natural products, or any combination thereof. In some embodiments, the biomolecule is selected from the group of proteins, nucleic acids, lipids, and metabolomes.

### Mass Spectrometry

Proteins comprise a large numbers of amino acids and are typically of significant molecular weight. Thus, accurate identification and quantitation of the protein by direct mass spectrometric measurement is challenging and generally requires using tandem mass spectrometry.

Most tandem mass spectrometers' ion transmission efficiency is poor due to a mismatch in the fast rate of MSI isolation and the slow speed of MS2 scan. Each window can contain 300-500 precursors for a highly complex sample. Such a population of precursors typically requires a high resolution from the mass analyzer, which can be delivered using high-resolution mass analyzers at the cost of scan speed. A slow scan speed can keep the analyzer occupied for extended periods, making it unavailable to accept ions from a second isolation window. Ions from the second isolation window or subsequent windows may be lost until a mass analyzer is freed up to accept ions, reducing the number of points that can be collected across a chromatographic peak. This constraint is common among present-generation mass spectrometers and can be referred to as a low-duty cycle problem.

An ion trap mass analyzer is unique in its ability to trap a population of ions and sequentially isolate all precursor ions with no loss of ions in the trap. Such a high-duty cycle process converts a significantly higher fraction of precursor ions in an MS1 scan into MS2 fragments for peptide sequencing. One way of addressing the low duty-cycle issue is to use an array of ion trap like ion storage cells to buffer ions to compensate for slow scan speed by storing ions from a peak of interest, where ions are stored in cells until the mass analyzer is available to accept the ions. However, these cells have a limited storage capacity, which is insufficient alone for high-throughput proteomic analysis. For example, fast gradients such as 30 mins or less deliver significant counts of peptides per isolation window that convert to high ion counts. The high ion current flux and temporal proximity of chromatographic peaks can overwhelm the capacity of a storage cell. Ion manifolds of this disclosure may eliminate the need for storage cells and/or enhances their use by removing the need to “buffer” the ion flux.

Analysis of samples by tandem mass spectrometry can generally be classified as data independent analysis/acquisition (DIA) and data dependent analysis/acquisition (DDA) methods. DIA can be useful to determine what is present in a sample of potentially unknown identity. To determine the molecular structure of sample molecules, a mass spectrometer is typically first used to mass analyze all sample ions (precursor ions) within a selected window of mass to charge ratio (m/z). Such a scan is often denoted as an MS1 scan. The selected sample ions are then fragmented and the resulting fragments are subsequently mass analyzed across the selected m/z range. The scan of the fragmented ions is often denoted as an MS2 scan.

DDA is typically useful to confirm that one or more species is/are present in a given sample. Methods of DDA identify a fixed number of precursor ion species, and select and analyze those via mass spectrometry by providing a more comprehensive mapping of fragments to individual parent ions. The determination of which precursor ion species are of interest in DDA may be based upon intensity ranking (for example, the top ten most abundant species as observed by peaks in a MS1 spectrum), or by defining an “inclusion list” of precursor mass spectral peaks (for example by user selection), from which MS2 spectra are always acquired regardless of the intensity ranking of the peak in the MS1 mass spectrum. Still otherwise, an “exclusion list” of peaks in MS1 can be defined, for example by a user, based e.g. on prior knowledge of the expected sample contents.

DIA avoids the decisions typically necessary in DDA, by simply dividing the mass range of interest (typically user defined) into segments and obtaining MS2 spectra for each segment. With DIA, the acquisition of an MS1 precursor spectrum may be omitted, since the parameters of the selection window for the sample ions carries information about the range of possible sample ions within that window.

One significant advantage of the ion manifolds described herein are that use of multiple mass analyzers in parallel may allow for near-zero dead time in MS/MS analysis. Accordingly, mass spectrometers comprising a plurality of mass analyzers and an ion manifold as described herein can allow for scanning in a “pseudo-DDA” mode, wherein DIA is operated using very small mass windows, which results in a 1:1 or near 1:1 mapping of parent ions to MS2 spectra. For example, a method of DIA analysis using a mass window of less than 5 amu (e.g. less than 4, 3, 2, 1, or 0.5 amu) for each MS2 scan is discussed above. This relatively narrow mass window is similar to targeted mass windows used in a typical DDA approach. By using relatively narrow mass windows for each of the MS2 scans, the resulting MS2 spectra may be analyzed using DDA type databases and can provide a similar level of insight, rather than requiring subsequent experiments with full DIA scans.

The ion manifolds described herein may address one problem with using such a narrow mass window for each of the MS2 scans, which is that the number of scans required to build up a full range of MS2 scans for the mass range of interest increases. As a result, the time taken to perform a complete DIA analysis can become overly long, for example much longer than the duration of a chromatographic peak. If the DIA analysis is not completed within the duration of the chromatographic peak, the analysis may not provide meaningful data, as some parts of the analysis will not measure the sample peak.

Another problem that may be solved by the methods and ion manifolds described herein, is that the relatively narrow mass windows for each MS2 scan result in relatively few, if any, fragmenting ions reaching the detector at a given time. Thus, reducing the mass selection window for each MS2 scan results in a reduction in the mass accuracy and/or the sensitivity of the MS2 mass analyzer. This problem is exacerbated when attempting to perform a large number of MS2 scans at a sufficient frequency to fit all MS2 scans within the duration of a chromatographic peak.

Utilizing multiple mass analyzers coupled to an ion manifold with a plurality of ion outlets can overcome one or more of these problems by eliminating or reducing analytical dead time and increasing ion transmission from an ion source to a detector through a tandem MS.

For pseudo-DDA analysis, narrow window DIA is repeated a number of times over the duration of a chromatographic peak. Accordingly, the cycle time of the DIA measurement may be adapted to be performed a plurality of times over the duration of a chromatographic peak. By performing DIA a number of times over the duration of the chromatographic peak, the peak may be sampled a number of times, allowing a complete picture of the peak to be established. The DIA methodology can be performed at least: 3, 4, 5, 7, 9 or preferably at least 10 times over the duration of a chromatographic peak.

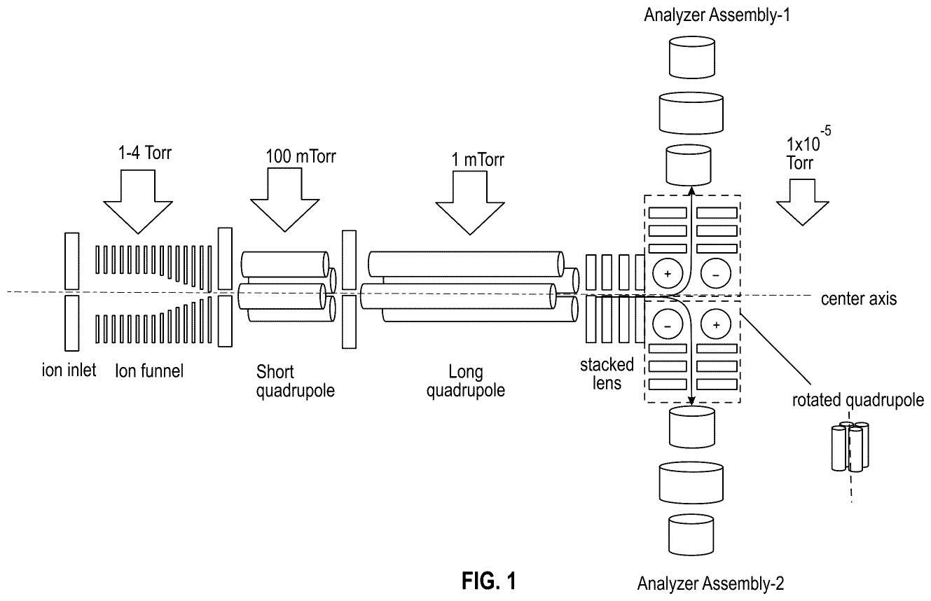

As a solution, ion manifolds of this disclosure, in some embodiments, allow for continuous processing of ions using an array of mass analyzers without needing to store ions for a significant period of time. For example, while a mass analyzer processes precursor ions in the first window, ions from the second DIA window are sent to a second mass analyzer, which scans in parallel, increasing duty cycle by reducing (or even eliminating) dead-time. This can be accomplished, for example, using a mass spectrometer with two or more mass analyzers (such as is detailed in FIGS. 1).

The location of the ion manifold in the mass spectrometer is not particularly limited, and may divide or direct the ion flux at various regions along the ion path between the ionization source and the mass analyzers. In some embodiments, the ion manifold is configured to divide or direct ion flux between the ionization source and the mass analyzers. In some embodiments, the ion manifold is configured to divide or direct ion flux between the ionization source and one or more field asymmetric ion mobility spectrometry devices. In some embodiments, the ion manifold is configured to divide or direct ion flux between the ionization source and one or more ion mobility devices. In some embodiments, the ion manifold is configured to divide or direct ion flux between the ionization source and one or more traveling-wave ion mobility spectrometry devices. In some embodiments, the ion manifold is configured to divide or direct ion flux between the ionization source and one or more trapped ion mobility spectrometry devices. In some embodiments, the ion manifold is configured to divide or direct ion flux between the ionization source and one or more drift-tube ion mobility spectrometry device. In some embodiments, the ion manifold is configured to divide or direct ion flux between a traveling-wave ion mobility spectrometry device and one or more mass filters (e.g., quadrupoles). In some embodiments, the ion manifold is configured to divide or direct ion flux between a trapped ion mobility spectrometry device and one or more mass filters (e.g., quadrupoles). In some embodiments, the ion manifold is configured to divide or direct ion flux between a drift-tube ion mobility spectrometry device and one or more mass filters (e.g., quadrupoles). In some embodiments, the ion manifold is configured to divide or direct ion flux between a traveling-wave ion mobility spectrometry device and one or more collision cells. In some embodiments, the ion manifold is configured to divide or direct ion flux between a trapped ion mobility spectrometry device and one ore more collision cells. In some embodiments, the ion manifold is configured to divide or direct ion flux between a drift-tube ion mobility spectrometry device and one or more collision cells. In some embodiments, the ion manifold is configured to divide or direct ion flux between a traveling-wave ion mobility spectrometry device and one or more mass analyzers. In some embodiments, the ion manifold is configured to divide or direct ion flux between a trapped ion mobility spectrometry device and one or more mass analyzers. In some embodiments, the ion manifold is configured to divide or direct ion flux between a drift-tube ion mobility spectrometry device and one or more mass analyzers. In some embodiments, the ion manifold is configured to divide or direct ion flux between a field asymmetric ion mobility spectrometry device and one or more traveling-wave ion mobility spectrometry devices. In some embodiments, the ion manifold is configured to divide or direct ion flux between a field asymmetric ion mobility spectrometry device and one or more trapped ion mobility spectrometry devices. In some embodiments, the ion manifold is configured to divide or direct ion flux between a field asymmetric ion mobility spectrometry device and one or more drift-tube ion mobility spectrometry devices.

### Ion Manifolds

Ion manifolds described herein are devices which can direct an ion flux entering through an inlet to a plurality of outlets in a configurable manner, either by selecting a particular outlet or by dividing the flux between selected outlets. Ion manifolds can comprise a series of electrodes in various geometries. Ion manifolds can comprise quadrupoles or other ion optics useful in guiding ions from the manifold inlet to the selected manifold outlet.

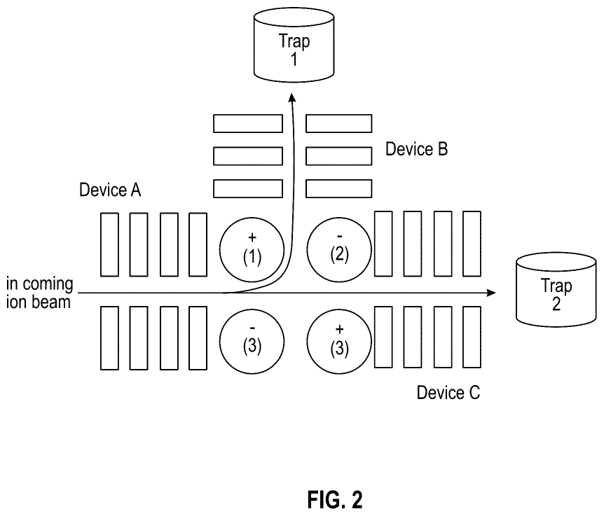

An example ion manifold which can select between two outlets is shown in FIG. 2. An ion beam directed by ion optics enters an ion switch, which can selectively direct the ion beam to one of two or more mass analyzers. Separate ion optics may be positioned before each mass analyzer. In some embodiments, the ion switch includes electrodes extending in a direction oblique or substantially perpendicular to the ion beam to selectively direct ions towards a mass analyzer.

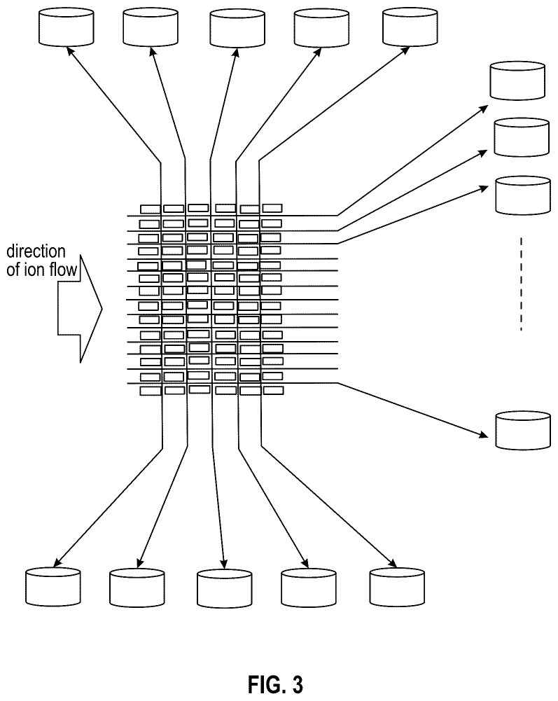

A further example of a manifold with an array of outlets is shown in FIG. 3. In some embodiments, a network of electrodes may be used to selectively direct incoming ions towards a particular mass analyzer. In some cases, a pair of parallel surfaces, each with a network of electrodes, may be used to selectively direct incoming ions toward a particular mass analyzer. As a non-limiting example, the parallel surfaces may be printed circuit boards (PCBs) having a network of electrodes configured to selectively control ion movement towards a plurality mass analyzers.

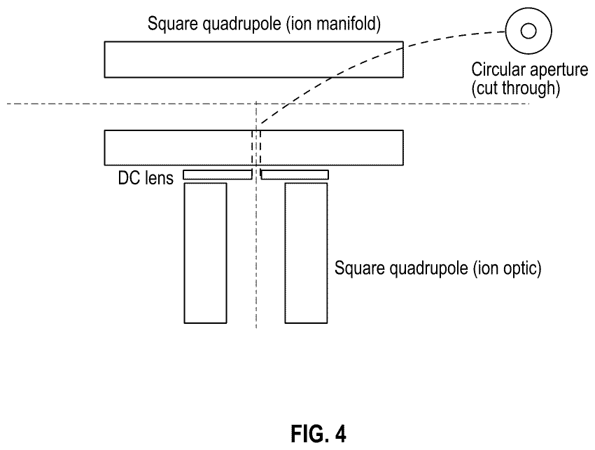

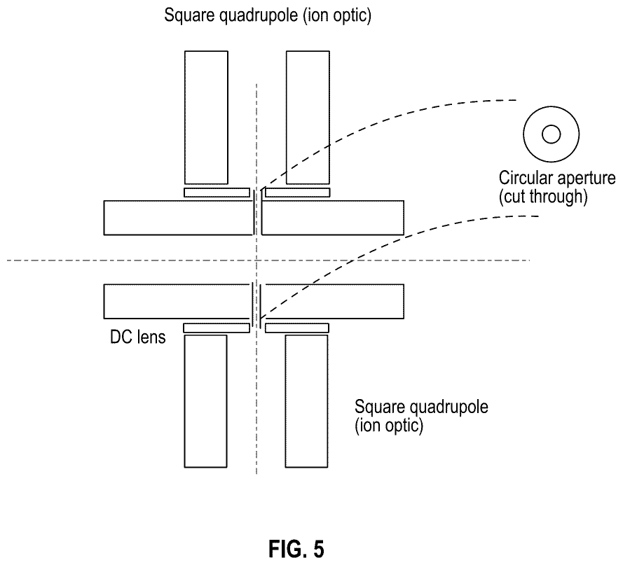

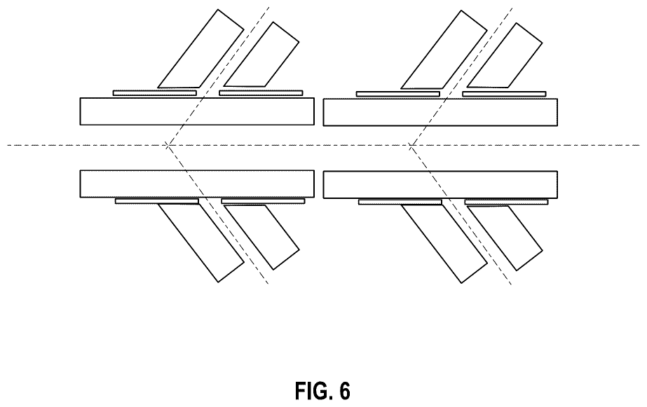

In some cases, ion manifolds of this disclosure can utilize a linear quadrupole. Manifold inlets and manifold outlets for a linear quadrupole-based ion manifold can comprise an aperature formed into one or more of the quadrupole electrodes (e.g. such as the circular aperature detailed in FIG. 4). The ion beam can be selectively directed through the aperture towards a first mass analyzer or directed past the aperture towards a second mass analyzer. A linear quadrupole based manifold can be rotated such that its axis is orthogonal to a beam of ions entering the quadrupole through an ion manifold inlet such as is detailed in FIGS. 1, 2, 4, and 5, or can be set at an angle such as is detailed in FIG. 6.

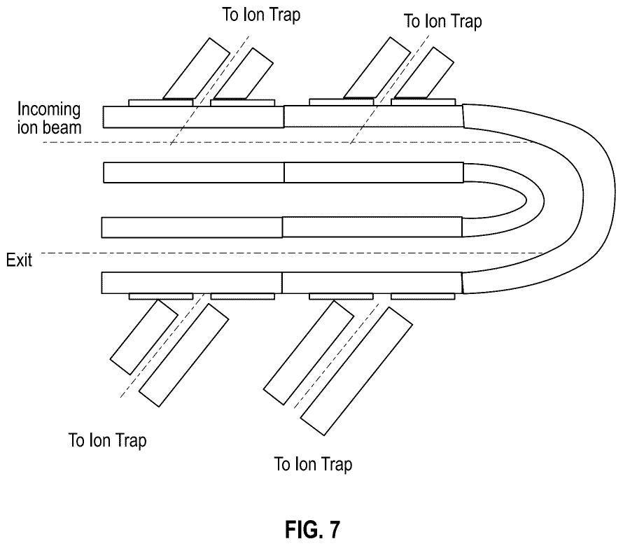

To save space and/or allow access to more manifold outlets, other quadropole geometries can be utilized for an ion manifold such as shown in FIG. 7. In this case, the quadrapole creates a curved path for the ion beam, and apertures are located along this path and operably coupled to separate mass analyzers. In some cases, the quadropole may have a serpentine path. The skilled person, guided by the teachings in the present application, will appreciate other configurations for the quadropole.

Ions can be guided through an ion manifold utilizing a quadrupole by applying the appropriate RF and/or DC fields to guide the ion flux from the inlet of the manifold to one or more selected outlets.

In some embodiments, the ion manifolds may include one or more split ion funnels that divide an ion beam along two or more paths operably coupled to the ion outlets. In some embodiments, the ion manifolds may include one or more multipoles having interlaced electrodes configured to divide an ion beam along two or more paths operably coupled to the ion outlets.

### Ion Mobility

Methods and mass spectrometers described herein can utilize one or more ion mobility devices within the ion optics of a mass spectrometer to discriminate between and/or separate analyte ions and background ions within an ion flux prior to analysis with one or more mass analyzer. Ion mobility systems can include Field asymmetric ion mobility spectrometry devices (FAIMS), traveling-wave ion mobility spectrometry devices (TWIMS), trapped ion mobility spectrometry devices (TIMS), drift-tube ion mobility spectrometry devices (DT-IMS), and/or combinations thereof. In some embodiments, the methods and mass spectrometers include both FAIMS and TWIMS.

Combining FAIMS with TWIMS or another secondary ion mobility separation device can reduce or eliminate the need for a high resolution FAIMS separation. A reduced resolution requirement allows for operation of FAIMS at reduced pressure which reduces loss of ion flux usually associated with ion-neutral collisions and/or ion-ion recombination. In some instances, FAIMS can be used as a filter. For example, a set of conditions can be applied to pass a selected class of ions, ions outside the transmission conditions (e.g. non-selected ions) are removed. A FAIMS device can operate at reduced pressure, for example, between 1-4 Torr with enough resolution to separate between two aggregate class of ions, for example, a separation between singly charged chemical background species and multiply charged peptide ions. Singly charged ions can be removed, reducing the total ion flux, and enriching for multiply charged ions that can be passed to downstream analysis, preserving the ions of interest and enhancing the performance of the subsequent TWIMS separation, which can be used to improve utilization of the mass analyzer, by separating peptides in time.

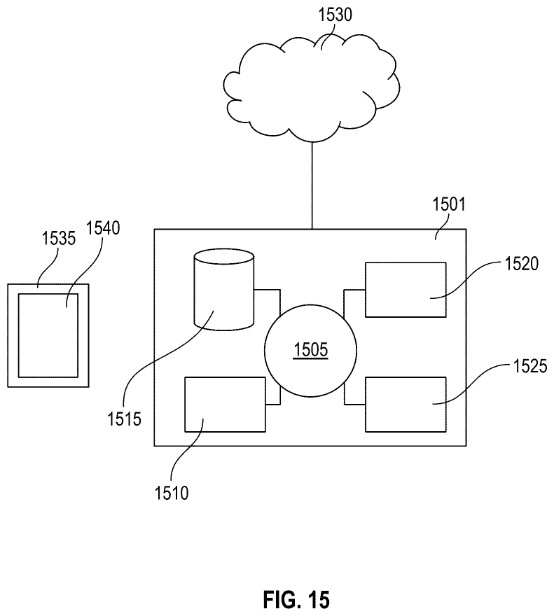

The present disclosure provides computer systems that are programmed to implement methods of the disclosure. FIG. 15 shows a computer system 1501 that is programmed or otherwise configured to implement the methods and systems described herein. The computer system 1501 can be an electronic device of a user or a computer system that is remotely located with respect to the electronic device. The electronic device can be a mobile electronic device.

The computer system 1501 includes a central processing unit (CPU, also “processor” and “computer processor” herein) 1505, which can be a single core or multi core processor, or a plurality of processors for parallel processing. The computer system 1501 also includes memory or memory location 1510 (e.g., random-access memory, read-only memory, flash memory), electronic storage unit 1515 (e.g., hard disk), communication interface 1520 (e.g., network adapter) for communicating with one or more other systems, and peripheral devices 1525, such as cache, other memory, data storage and/or electronic display adapters. The memory 1510, storage unit 1515, interface 1520 and peripheral devices 1525 are in communication with the CPU 1505 through a communication bus (solid lines), such as a motherboard. The storage unit 1515 can be a data storage unit (or data repository) for storing data. The computer system 1501 can be operatively coupled to a computer network (“network”) 1530 with the aid of the communication interface 1520. The network 1530 can be the Internet, an internet and/or extranet, or an intranet and/or extranet that is in communication with the Internet. The network 1530 in some cases is a telecommunication and/or data network. The network 1530 can include one or more computer servers, which can enable distributed computing, such as cloud computing. The network 1530, in some cases with the aid of the computer system 1501, can implement a peer-to-peer network, which may enable devices coupled to the computer system 1501 to behave as a client or a server.

The CPU 1505 can execute a sequence of machine-readable instructions, which can be embodied in a program or software. The instructions may be stored in a memory location, such as the memory 1510. The instructions can be directed to the CPU 1505, which can subsequently program or otherwise configure the CPU 1505 to implement methods of the present disclosure. Examples of operations performed by the CPU 1505 can include fetch, decode, execute, and writeback.

The CPU 1505 can be part of a circuit, such as an integrated circuit. One or more other components of the system 1501 can be included in the circuit. In some cases, the circuit is an application specific integrated circuit (ASIC).

The storage unit 1515 can store files, such as drivers, libraries and saved programs. The storage unit 1515 can store user data, e.g., user preferences and user programs. The computer system 1501 in some cases can include one or more additional data storage units that are external to the computer system 1501, such as located on a remote server that is in communication with the computer system 1501 through an intranet or the Internet.

The computer system 1501 can communicate with one or more remote computer systems through the network 1530. For instance, the computer system 1501 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 1501 via the network 1530.

Methods as described herein can be implemented by way of machine (e.g., computer processor) executable code stored on an electronic storage location of the computer system 1501, such as, for example, on the memory 1510 or electronic storage unit 1515. The machine executable or machine readable code can be provided in the form of software. During use, the code can be executed by the processor 1505. In some cases, the code can be retrieved from the storage unit 1515 and stored on the memory 1510 for ready access by the processor 1505. In some situations, the electronic storage unit 1515 can be precluded, and machine-executable instructions are stored on memory 1510.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1501 can include or be in communication with an electronic display 1535 that comprises a user interface (UI) 1540 for providing, for example, selection of ion manifold injection parameters. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1505.

### EXAMPLE EMBODIMENTS

1. A multiplexed method of acquiring tandem mass spectra of a sample, the method comprising:
   ionizing the sample using an ion source to produce gas-phase ions;
   introducing the gas-phase ions into a mass spectrometer, the mass spectrometer comprising:
      a vacuum system;
      an ion inlet, operably coupled to the vacuum system;
      a first set of ion optics arranged within the vacuum system and configured to guide ions from the ion inlet toward an ion manifold within the vacuum system, the ion manifold comprising:
         an ion manifold inlet;
         a plurality of ion manifold outlets; and
         at least one ion outlet selector; and
      a second set of ion optics arranged within the vacuum system to guide ions from at least two of the plurality of ion manifold outlets to at least two mass analyzers, the at least two mass analyzers being disposed within, or operably coupled to, the vacuum system;
   selecting a first mass isolation window of a first one of the at least two mass analyzers corresponding to a first one of the plurality of ion manifold outlets;
   selecting a second mass isolation window of the at least two mass analyzers corresponding to a second one of the plurality of ion manifold outlets; and
   acquiring mass spectra of both the first and second mass isolation windows using the at least two mass analyzers.
2. A tandem mass spectrometer, the mass spectrometer comprising:
   a vacuum system;
   an ion inlet, operably coupled to the vacuum system;
   a first set of ion optics arranged within the vacuum system and configured to guide ions from the ion inlet toward an ion manifold within the vacuum system, the ion manifold comprising:
      an ion manifold inlet;
      a plurality of ion manifold outlets; and
      at least one ion outlet selector; and
   a second set of ion optics arranged within the vacuum system to guide ions from at least two of the plurality of ion manifold outlets to at least two mass analyzers, the at least two mass analyzers being disposed within, or operably coupled to, the vacuum system.
3. An ion manifold comprising:
   an ion manifold inlet;
   a plurality of ion manifold outlets; and
   at least one ion outlet selector;
   wherein the at least one ion outlet selector is configurable to direct an ion flux entering through the ion manifold inlet to one or more selected outlets of the plurality of ion manifold outlets.
4. The method, the mass spectrometer, or the ion manifold of any of the preceding embodiments, wherein the ion outlet selector comprises at least one quadrupole disposed between the ion manifold inlet and the plurality of ion manifold outlets.
5. The method, the mass spectrometer, or the ion manifold of embodiment 4, wherein the at least one quadrupole is configurable to guide ions toward a selected one of the plurality of ion manifold outlets.
6. The method, the mass spectrometer, or the ion manifold of any of the preceding embodiments, wherein the ion outlet selector comprises a plurality of RF and/or DC ion guide lenses.
7. The method, the mass spectrometer, or the ion manifold of any of the preceding embodiments, wherein the ion manifold directs the ion flux from the ion manifold inlet, to two or more ion manifold outlets simultaneously, or near simultaneously.
8. The method or the mass spectrometer of any of the preceding embodiments, wherein the first set of ion optics comprises an ion funnel, a plurality of ion lenses, and one or more quadrupole ion guides.
9. The method or the mass spectrometer of any of the preceding embodiments, wherein the at least two mass analyzers are disposed in a single chamber of the vacuum system.
10. The method or the mass spectrometer of any of the preceding embodiments, wherein the vacuum system comprises a plurality of vacuum chambers.
11. The method or the mass spectrometer of any of embodiments 1-8, or 10, wherein the at least two mass analyzers are comprised in separate chambers of the vacuum system.
12. The method or the mass spectrometer of embodiment 10, wherein the plurality of vacuum chambers are differentially pumped such that each chamber has a pressure different from the pressure in at least one of the other chambers.
13. The method or the mass spectrometer of any of the preceding embodiments, wherein each of the at least two mass analyzers are operated at the same or substantially the same pressure (e.g. wherein a pressure difference between vacuum chambers of each mass analyzer differ by no more than 30%).
14. The method or the mass spectrometer of embodiment 12, wherein the vacuum system comprises a plurality of vacuum chambers upstream of the ion manifold inlet.
15. The method, the mass spectrometer, or the ion manifold of any of the preceding embodiments, wherein the plurality of ion manifold outlets comprise two ion manifold outlets.
16. The method, the mass spectrometer, or the ion manifold of any of the preceding embodiments, wherein the plurality of ion manifold outlets comprise at least three (e.g. at least 3, 4, or 5) ion manifold outlets.
17. The method or the mass spectrometer of any of the preceding embodiments, wherein the at least two mass analyzers comprise at least three (e.g. at least 3, 4, or 5) mass analyzers.
18. The method or the mass spectrometer of any of the preceding embodiments, wherein the at least two mass analyzers share common control electronics (e.g. for control of ion manipulation, RF, and/or DC fields of the mass analyzers).
19. The method, the mass spectrometer, or the ion manifold of any of embodiments 4-18, wherein the at least one quadrupole disposed between the ion manifold inlet and the plurality of ion manifold outlets comprises a linear quadrupole.
20. The method, the mass spectrometer, or the ion manifold of embodiment 19, wherein the axis of the linear quadrupole is substantially orthogonal to the ion manifold inlet axis.
21. The method or the mass spectrometer of any of the preceding embodiments wherein each of the at least two mass analyzers is independently selected from a linear quadrupole ion trap mass analyzer, a three dimensional quadrupole ion trap mass analyzer, an electrostatic axially harmonic orbital trapping mass analyzer, a time-of-flight mass analyzer, a distance-of-flight mass analyzer, a magnetic sector mass analyzer, a Fourier-transform ion cyclotron residence (FT-ICR) mass analyzer, and a linear quadrupole mass analyzer.
22. The method or the mass spectrometer of embodiment 21, wherein each of the at least two mass analyzers are electrostatic axially harmonic orbital trapping, FT-ICR, or time-of-flight mass analyzers.
23. The method or the mass spectrometer of embodiment 22, wherein each of the at least two mass analyzers are electrostatic axially harmonic orbital trapping mass analyzers.
24. The method or the mass spectrometer of embodiment 22, wherein each of the at least two mass analyzers are FT-ICR mass analyzers.
25. The method or the mass spectrometer of embodiment 22, wherein each of the at least two mass analyzers are linear quadrupole ion trap mass analyzers.
26. The method or the mass spectrometer of embodiment 22, wherein each of the at least two mass analyzers are time-of-flight mass analyzers.
27. The method or the mass spectrometer of any of the preceding embodiments, wherein the time-of-flight mass analyzer is a sector time-of-flight mass analyzer or an orthogonal acceleration time-of-flight mass analyzer.
28. The method or the mass spectrometer of embodiment 27, wherein the time-of-flight mass analyzer is a sector time-of-flight mass analyzer.
29. The method or the mass spectrometer of embodiment 27, wherein the time-of-flight mass analyzer is an orthogonal acceleration time-of-flight mass analyzer.
30. The method or the mass spectrometer of any of the preceding embodiments, wherein the first set of ion optics comprises a field asymmetric waveform ion mobility spectrometry device.
31. The method or the mass spectrometer of any of the preceding embodiments, wherein the first set of ion optics comprises a traveling wave ion mobility spectrometry device (TWIMS) or a trapped ion mobility spectrometry device (TIMS).
32. The method or the mass spectrometer of embodiment 31, wherein the mass spectrometer comprises a field asymmetric waveform ion mobility spectrometry device upstream of the a traveling wave ion mobility spectrometry device (TWIMS) or trapped ion mobility spectrometry device (TIMS).
33. The method or the mass spectrometer of embodiment 32, wherein the field asymmetric waveform ion mobility spectrometry device is configured to operate below atmospheric pressure and to discriminate or select between singly charged and multiply charged ions.
34. The method or the mass spectrometer of any of the preceding embodiments, wherein each of the mass analyzers is configured to scan across an independently selected mass range during at least partially overlapping periods of time.
35. The method or the mass spectrometer of any of the preceding embodiments, wherein each of the mass analyzers is configured to scan across an independently selected mass range at essentially the same time.
36. The method or the mass spectrometer of any of the preceding embodiments, wherein the second set of ion optics comprises one or more collision activated dissociation cells each disposed between one or more of the ion manifold outlets and one or more of the at least two mass analyzers.
37. The method or the mass spectrometer of any of the preceding embodiments, wherein the second set of ion optics comprises one or more quadrupole mass filters each disposed between one or more of the ion manifold outlets and one or more of the at least two mass analyzers.
38. The method, the mass spectrometer, or the ion manifold of any of the preceding embodiments, wherein each of the plurality of ion manifold outlets are selectively gated to stop or pass the ion flux using a set of stacked DC lenses corresponding to the individual ion manifold outlet.
39. The method or the mass spectrometer of any of the preceding embodiments, wherein the ion manifold and the at least two mass analyzers comprise at least a minimum number of ion manifold outlets and a minimum number of mass analyzers required to reduce dead time when sequential ion injections are used to provide near simultaneous mass analysis of the different mass to charge isolation windows.
40. The method, the mass spectrometer, or the ion manifold of any of the preceding embodiments, wherein a pressure in the ion manifold during operation is less than about 10 μTorr.
41. The method of any of the preceding embodiments, wherein the ion source is an atmospheric pressure ion source.
42. The method of embodiment 41, wherein the ion source is electrospray ionization (ESI).
43. The method of embodiment 42, wherein the ion source is a nano-electrospray emitter.
44. The method of any of the preceding embodiments, further comprising:
   selecting a third mass isolation window of a third one of the at least two mass analyzers corresponding to a third one of the plurality of ion manifold outlets; and
      acquiring mass spectra of the first, second, and third mass isolation windows using the at least two mass analyzers.
45. The method of any of the preceding embodiments, further comprising:
   selecting a fourth mass isolation window of a fourth one of the at least two mass analyzers corresponding to a fourth one of the plurality of ion manifold outlets; and
      acquiring mass spectra of the first, second, third, and fourth mass isolation windows using the at least two mass analyzers.
46. The method of any of the preceding embodiments, wherein the mass spectra are acquired near simultaneously by sequentially injecting ions into the at least two mass analyzers through the plurality of ion manifold outlets.
47. The method of embodiment 46, wherein the dead time for near simultaneous acquisition by sequential ion injections is essentially zero.
48. The method of any of the preceding embodiments further comprising, selecting an ion injection timing sequence during which a plurality of outlets of the ion manifold are to be selected using the ion manifold selector.
49. A multiplexed method of acquiring tandem mass spectra of a sample, the method comprising:
   ionizing the sample using an ion source to produce gas-phase ions;
   introducing the gas-phase ions into a mass spectrometer, the mass spectrometer comprising:
      a vacuum system;
      at least one ion inlet, operably coupled to the vacuum system;
      a first set of ion optics arranged within the vacuum system comprising a field asymmetric waveform ion mobility spectrometry device and a traveling wave ion mobility spectrometry device (TWIMS) or a trapped ion mobility spectrometry device (TIMS), wherein the field asymmetric waveform ion mobility spectrometry device is upstream of the traveling wave ion mobility spectrometry device (TWIMS) or the trapped ion mobility spectrometry device, and wherein the field asymmetric waveform ion mobility spectrometry device is designed to operate at less than atmospheric pressure; and
      a second set of ion optics arranged within the vacuum system to guide ions passing through the first set of ion optics to at least one mass analyzer, the at least one mass analyzers being disposed within, or operably coupled to, the vacuum system, the second set of ion optics further comprising at least one collision cell and at least one upstream mass filter corresponding to each of the at least one mass analyzer; and
   selecting a first mass window of the upstream mass filter and/or a collision energy of the collision cell corresponding to the at least one mass analyzer; and
      acquiring a mass spectrum using the at least one mass analyzers.
50. A tandem mass spectrometer, the mass spectrometer comprising:
   a vacuum system;
   an ion inlet, operably coupled to the vacuum system;
   a first set of ion optics arranged within the vacuum system comprising a field asymmetric waveform ion mobility spectrometry device and a traveling wave ion mobility spectrometry device (TWIMS) or a trapped ion mobility spectrometry device (TIMS), wherein the field asymmetric waveform ion mobility spectrometry device is upstream of the traveling wave ion mobility spectrometry device (TWIMS) or the trapped ion mobility spectrometry device, and wherein the field asymmetric waveform ion mobility spectrometry device is designed to operate at less than atmospheric pressure; and
   a second set of ion optics arranged within the vacuum system to guide ions from the first set of ion optics to at least one mass analyzer, the at least one mass analyzer being disposed within, or operably coupled to, the vacuum system, the second set of ion optics further comprising at least one collision cell disposed between an ion inlet of the second set of ion optics and the at least one mass analyzer, the at least one collision cell being configured to control a collision energy applied to ion passing through the cell.
51. The mass spectrometer of embodiment 50, wherein the second set of ion optics further comprises at least one upstream mass filter corresponding to each of the at least one mass analyzers, the upstream mass filter being upstream of the at least one collision cell.
52. The method or the mass spectrometer of any one of embodiments 49-51, wherein the second set of ion optics comprises a second collision cell and/or a second mass filter corresponding to each of the at least one mass analyzers.
53. The method of embodiment 52, further comprising selecting a first upstream mass window of the first mass filter and/or a collision energy of the first collision cell;
   selecting a second mass window of the second upstream mass filter and/or a collision energy of the second collision cell corresponding; and
   acquiring mass spectra of both the first and second mass windows and/or of the first and second collision energies using the at least one mass analyzer.
54. The method or the mass spectrometer of any one of embodiments 49-53, wherein the first set of ion optics further comprises a plurality of ion lenses and/or one or more quadrupole ion guides.
55. The method or the mass spectrometer of any one of embodiments 49-54, wherein the at least one mass analyzer comprises at least two mass analyzers, disposed in a single chamber of the vacuum system.
56. The method or the mass spectrometer of any one of embodiments 49-55, wherein the vacuum system comprises a plurality of vacuum chambers.
57. The method or the mass spectrometer of any one of embodiments 49-56, wherein the at least one mass analyzer comprises at least two mass analyzers are comprised in separate chambers of the vacuum system.
58. The method or the mass spectrometer of any one of embodiments 49-57, wherein the plurality of vacuum chambers are differentially pumped such that each chamber has a pressure different from the pressure in at least one of the other chambers.
59. The method or the mass spectrometer of any one of embodiments 49-58, wherein each of the at least two mass analyzers are operated at the same or substantially the same pressure (e.g. wherein a pressure difference between vacuum chambers of each mass analyzer differ by no more than 30%).
60. The method or the mass spectrometer of any one of embodiments 49-59, wherein the vacuum system comprises a plurality of vacuum chambers downstream of the ion manifold inlet.
61. The method or the mass spectrometer of any one of embodiments 49-60, wherein the at least one mass analyzer comprises at least three (e.g. at least 3, 4, or 5) mass analyzers.
62. The method or the mass spectrometer of any one of embodiments 55or 61, wherein the at least two mass analyzers share common control electronics (e.g. for control of ion manipulation, RF, and/or DC fields of the mass analyzers).
63. The method or the mass spectrometer of any one of embodiments 49-62, wherein each of the at least one mass analyzers are independently selected from a linear quadrupole ion trap mass analyzer, a three dimensional quadrupole ion trap mass analyzer, an electrostatic axially harmonic orbital trapping mass analyzer, a time-of-flight mass analyzer, a distance-of-flight mass analyzer, a magnetic sector mass analyzer, a Fourier-transform ion cyclotron residence (FT-ICR) mass analyzer, and a linear quadrupole mass analyzer.
64. The method or the mass spectrometer of any one of embodiments 49-63, wherein each of the at least one mass analyzers are electrostatic axially harmonic orbital trapping, FT-ICR, or time-of-flight mass analyzers.
65. The method or the mass spectrometer of any one of embodiments 49-64, wherein each of the at least one mass analyzers are electrostatic axially harmonic orbital trapping mass analyzers.
66. The method or the mass spectrometer of any one of embodiments 49-65, wherein each of the at least one mass analyzers are FT-ICR mass analyzers.
67. The method or the mass spectrometer of any one of embodiments 49-66, wherein each of the at least one mass analyzers are linear quadrupole ion trap mass analyzers.
68. The method or the mass spectrometer of any one of embodiments 49-67, wherein each of the at least one mass analyzers are time-of-flight mass analyzers.
69. The method or the mass spectrometer of any one of embodiments 49-68, wherein the field asymmetric waveform ion mobility spectrometry device is configured to discriminate or select between singly charged and multiply charged ions.
70. The method or the mass spectrometer of any one of embodiments 55, 61, or 62-69, wherein each of the mass analyzers is configured to scan across an independently selected mass range during at least partially overlapping periods of time.
71. The method or the mass spectrometer of any one of embodiments 55, 61, or 62-70, wherein each of the mass analyzers is configured to scan across an independently selected mass range at essentially the same time.
72. The method or the mass spectrometer of any one of embodiments 49-71, wherein the ion source is an atmospheric pressure ion source.
73. The method or the mass spectrometer of embodiment 72, wherein the ion source is electrospray ionization (ESI).
74. The method or the mass spectrometer of embodiment 73, wherein the ion source is a nano-electrospray emitter.
75. The method of any of the preceding embodiments, wherein the sample is a biological sample.
76. The method of any of the preceding embodiments, wherein the sample is a proteomics sample.
77. The method of any of the preceding embodiments, wherein the sample comprises at least 100 different proteins.
78. The method of any of the preceding embodiments, wherein the sample is obtained from a chromatographic separation prior to analysis.
79. The method of any of the preceding embodiments, wherein tandem mass spectra are acquired in DIA mode.
80. The method of any of the preceding embodiments, wherein tandem mass spectra are acquired in DDA mode.
81. The method of any of the preceding embodiments, wherein the tandem mass spectra are acquired in pseudo-DDA mode.
82. The method of any of the preceding embodiments, wherein the MS1 mass window is less than about 2 amu (e.g. 2, 1, or 0.5 amu).
83. The method of any of the preceding embodiments, wherein the MS1 mass window is less than about 10 amu.
84. The method of any of the preceding embodiments, wherein the MS1 mass window is less than about 5 amu.
85. The method of any of the preceding embodiments, wherein the MS1 mass window is less than about 4 amu.
86. The method of any of the preceding embodiments wherein the MS2 resolving power is at least 10,000 (e.g. at least 10,000, at least 30,000, at least 50,000, at least 300,000, or at least 1,000,000).
87. The method of any of the preceding embodiments wherein the MS2 resolving power is less than 10,000,000 (e.g. less than 5,000,000, less than 1,000,000, less than 100,000, or less than 50,000).
88. The method of any of the preceding embodiments wherein at least 1000 peptides (e.g. at least 5000, at least 10,000, or at least 20,000) are identified in the sample.
89. A method of analyzing a biological sample comprising:
   incubating a sensor element with a biological sample to form a biomolecule corona on the sensor element;
   isolating biomolecules from the biomolecule corona; and
   analyzing the biomolecules using the method of any of the preceding embodiments.
90. Use of the tandem mass spectrometer of any of the preceding embodiments for analyzing a proteomic sample.
91. Use of the tandem mass spectrometer of any of the preceding embodiments for analyzing a biological sample.
92. Use of the tandem mass spectrometer of any of the preceding embodiments for analyzing biomolecules in a biomolecule corona.
93. A method comprising:
   separating a biological sample over time (e.g., by liquid chromatography);
   ionizing the biological sample as the biological sample is being separated;
   introducing the gas-phase ions from the separated biological sample into a field asymmetric waveform ion mobility spectrometry device to selectively remove singly-charged ions;
   introducing multiply-charged gas-phase ions from the field asymmetric waveform ion mobility spectrometry device to a travelling wave ion mobility device to separate the multiply-charged ions based on mobility;
   sequentially introducing windows of ions having different ion mobilities from the travelling wave ion mobility spectrometry device into a collision cell and fragmenting the windows of ions; and
   sequentially analyzing the different windows of fragmented ions using a time-of-flight mass analyzer, wherein at least 100 different windows corresponding to different ion mobilities are analyzed each second.
94. The method of embodiment 93, further comprising filtering the windows of ions having different ion mobilities to remove ions outside of a window of 10 amu or less, wherein said filtering occurs before the introducing of ions into the collision cell.
95. The method of embodiment 93, wherein the ions having different ion mobilities from the travelling wave ion mobility spectrometry device are not filtered based on m/z before introducing into the collision cell.
96. The method of any one of embodiments 93-95, wherein the time-of-flight mass analyzer is a sector time-of-flight mass analyzer.
97. The method of any one of embodiments 93-95, wherein the time-of-flight mass analyzer is an orthogonal acceleration time-of-flight mass analyzer.
98. The method of any one of embodiments 93-97, wherein sequentially analyzing the different windows of fragmented ions uses a plurality of time-of-flight mass analyzers.
99. The method of any one of embodiments 93-98, wherein the field asymmetric waveform ion mobility spectrometry device is maintained at a pressure below 100 torr.
100. A system comprising:
   a liquid chromatography device configured to separate a biological sample over time;
   an electrospray ionization device configured to ionize the biological sample while being separated by the liquid chromatography device;
   a field asymmetric waveform ion mobility spectrometry device configured to selectively remove singly-charged gas-phase ions received from the electrospray ionization device;
   a travelling wave ion mobility device configured to separate multiply-charged ions received from the field asymmetric waveform ion mobility spectrometry device based on mobility; and
   a collision cell configured to fragment ion-mobility-sorted, multiply charged ions received from the travelling wave ion mobility device; and
   a time-of-flight mass analyzer configured to analyze the fragmented ions from the collisional cell.
101. The system of embodiment 100, further comprising a mass filter configured to filter windows of ions having different ion mobilities from the travelling waive ion mobility device to remove ions outside of a window of 10 amu or less before introduction into the collision cell.
102. The system of embodiment 100, wherein the system does not include a mass filter to remove ions received from the travelling wave ion mobility device before introduction into the collision cell.
103. The system of any one of embodiments 100-102, wherein the time-of-flight mass analyzer is a sector time-of-flight mass analyzer.
104. The system of any one of embodiments 100-102, wherein the time-of-flight mass analyzer is an orthogonal acceleration time-of-flight mass analyzer.
105. The system of any one of embodiments 100-104, wherein the system comprises a plurality of time-of-flight mass analyzers configured.
106. The system of any one of embodiments 100-105, wherein the field asymmetric waveform ion mobility spectrometry device is configured to remove singly-charged ions at a pressure below 100 torr.
107. A tandem mass spectrometer, the mass spectrometer comprising:
   a vacuum system;
   an ion inlet, operably coupled to the vacuum system;
   a first set of ion optics arranged within the vacuum system and configured to guide ions from the ion inlet toward an ion manifold within the vacuum system, the ion manifold comprising:
      an ion manifold inlet;
      a plurality of ion manifold outlets; and
   at least one ion outlet selector; and
      a second set of ion optics arranged within the vacuum system to guide ions from at least two of the plurality of ion manifold outlets to at least two collision cells operably coupled to at least two mass analyzers, the at least two mass analyzers being disposed within, or operably coupled to, the vacuum system.
108. The mass spectrometer of embodiment 107, wherein the first set of ion optics comprises an ion mobility separation device.
109. The mass spectrometer of embodiment 108, wherein the ion mobility separation device is a field asymmetric waveform ion mobility spectrometry device.
110. The mass spectrometer of embodiment 108, wherein the ion mobility separation device is a travelling wave ion mobility device.
111. The mass spectrometer of embodiment 108, wherein the ion mobility separation device is a trapped ion mobility spectrometry device.
112. The mass spectrometer of embodiment 107, wherein the first set of ion optics comprises a field asymmetric waveform ion mobility spectrometry device and a travelling wave ion mobility device.
113. The mass spectrometer of embodiment 112, wherein the field asymmetric waveform ion mobility spectrometry device is configured to selectively remove singly-charged ions, and the travelling wave mobility device is configured to receive multiply-charged ions from the field asymmetric waveform ion mobility spectrometry device.
114. The mass spectrometer of embodiment 107, wherein the second ion optics comprises at least two ion mobility separation devices.
115. The mass spectrometer of embodiment 114, wherein the ion mobility separation devices comprise at least two field asymmetric waveform ion mobility spectrometry device.
116. The mass spectrometer of embodiment 114, wherein the ion mobility separation devices comprise at least two travelling wave ion mobility devices.
117. The mass spectrometer of embodiment 114, wherein the ion mobility separation devices comprise at least two trapped ion mobility spectrometry devices.
118. The mass spectrometer of embodiment 107, wherein the second set of ion optics comprises at least two field asymmetric waveform ion mobility spectrometry devices and at least two travelling wave ion mobility devices.
119. The mass spectrometer of embodiment 118, wherein each of the field asymmetric waveform ion mobility spectrometry devices is configured to selectively remove singly-charged ions, and each of the travelling wave ion mobility devices is configured to receive multiply-charged ions from one of the field asymmetric waveform ion mobility spectrometry devices.
120. The mass spectrometer of embodiment 107, wherein the first ion optics comprises a first ion mobility separation device, and wherein the second ion optics comprises a second ion mobility separation device and a third ion mobility separation device.
121. The mass spectrometer of embodiment 120, wherein the first ion mobility separation device is a field asymmetric waveform ion mobility spectrometry device.
122. The mass spectrometer of embodiment 121, wherein the field asymmetric waveform ion mobility spectrometry device is configured to selectively remove singly-charged ions.
123. The mass spectrometer of any one of embodiments 119-122, wherein the second ion mobility separation device is a travelling wave ion mobility device.
124. The mass spectrometer of any one of embodiments 119-123, wherein the third ion mobility separation device is a travelling wave ion mobility device.
125. The mass spectrometer of any one of embodiments 107-124, wherein the first set of ion optics comprises an ion funnel.
126. The mass spectrometer of any one of embodiments 107-125, wherein the second set of ion optics comprises at least two mass filters.
127. A multiplexed method of acquiring tandem mass spectra of a sample, the method comprising:
   ionizing the sample using an ion source to produce gas-phase ions;
   introducing the gas-phase ions into a mass spectrometer, the mass spectrometer comprising:
      a vacuum system;
      an ion inlet, operably coupled to the vacuum system;
      a first set of ion optics arranged within the vacuum system and configured to guide ions from the ion inlet toward an ion manifold within the vacuum system, the ion manifold comprising:
         an ion manifold inlet;
         a plurality of ion manifold outlets; and
         at least one ion outlet selector; and
      a second set of ion optics arranged within the vacuum system to guide ions from at least two of the plurality of ion manifold outlets to at least two mass filters, wherein each of the at least two mass filters operably coupled to one of at least two mass analyzers, wherein the at least two mass analyzers are disposed within, or operably coupled to, the vacuum system;
   selecting a first mass isolation window of a first one of the at least two mass analyzers corresponding to a first one of the plurality of ion manifold outlets;
   selecting a second mass isolation window of the at least two mass analyzers corresponding to a second one of the plurality of ion manifold outlets; and
   acquiring mass spectra of both the first and second mass isolation windows using the at least two mass analyzers.
128. The method of embodiment 127, wherein the first set of ion optics comprises an ion mobility separation device.
129. The method of embodiment 128, wherein the ion mobility separation device is a field asymmetric waveform ion mobility spectrometry device.
130. The method of embodiment 128, wherein the ion mobility separation device is a travelling wave ion mobility device.
131. The method of embodiment 128, wherein the ion mobility separation device is a trapped ion mobility spectrometry device.
132. The method of embodiment 127, wherein the first set of ion optics comprises a field asymmetric waveform ion mobility spectrometry device and a travelling wave ion mobility device.
133. The method of embodiment 132, wherein the field asymmetric waveform ion mobility spectrometry device is configured to selectively remove singly-charged ions, and the travelling wave mobility device is configured to receive multiply-charged ions from the field asymmetric waveform ion mobility spectrometry device.
134. The method of embodiment 127, wherein the second ion optics comprises at least two ion mobility separation devices.
135. The mass spectrometer of embodiment 134, wherein the ion mobility separation devices comprise at least two field asymmetric waveform ion mobility spectrometry device.
134. The mass spectrometer of embodiment 134, wherein the ion mobility separation devices comprise at least two travelling wave ion mobility device.
135. The mass spectrometer of embodiment 134, wherein the ion mobility separation devices comprise at least two trapped ion mobility spectrometry devices.
136. The method of embodiment 127, wherein the second set of ion optics comprises at least two field asymmetric waveform ion mobility spectrometry devices and at least two travelling wave ion mobility devices.
137. The method of embodiment 136, wherein each of the field asymmetric waveform ion mobility spectrometry devices is configured to selectively remove singly-charged ions, and each of the travelling wave ion mobility devices is configured to receive multiply-charged ions from one of the field asymmetric waveform ion mobility spectrometry devices.
138. The method of embodiment 127, wherein the first ion optics comprises a first ion mobility separation device, and wherein the second ion optics comprises a second ion mobility separation device and a third ion mobility separation device.
139. The method of embodiment 138, wherein the first ion mobility separation device is a field asymmetric waveform ion mobility spectrometry device.
140. The method of embodiment 139, wherein field asymmetric waveform ion mobility spectrometry device is configured to selectively remove singly-charged ions.
141. The method of any one of embodiments 138-140, wherein the second ion mobility separation device is a travelling wave ion mobility device.
142. The method of any one of embodiments 138-141, wherein the third ion mobility separation device is a travelling wave ion mobility device.
143. The method of any one of embodiments 127-142, wherein the first set of ion optics comprises an ion funnel.
144. The method of any one of embodiments 127-143, wherein the second set of ion optics comprises at least two collision cells.

### EXAMPLES

The following examples are provided to further illustrate some embodiments of the present disclosure, but are not intended to limit the scope of the disclosure; it will be understood by their exemplary nature that other procedures, methodologies, or techniques known to those skilled in the art may alternatively be used.

### Example 1: Two-Analyzer Mass Spectrometer comprising an Ion Manifold

An example of a mass spectrometer implementing an ion manifold of this disclosure is shown in FIG. 1. Ions are generated at atmospheric pressure using an electrospray ion source and are sampled through an ion inlet or narrow aperture of 0.25-1 mm in inner diameter or less. The aperture also acts as an interface between the atmospheric pressure (760 Torr) and the first pumping stage of the mass spectrometer. An electrodynamic ion funnel is placed in the first pumping stage (1-4 Torr) to collect ions. Due to a steep pressure differential between 760 Torr and the second stage, gas entering the ion funnel expand chaotically into a supersonic expansion, scattering ions. The electrodynamic ion funnel acceptance radius is tailored to capture the ion plume. The ions traverse through the funnel and exit into a short quadrupole placed in a 100 mTorr pressure stage. A second quadrupole is placed in a lower pressure stage to guide the ion beam into the final pressure stage, an ultra-high vacuum (1×10⁻⁵) region that contains the mass analyzers.

Ions delivered into the ultra-high vacuum enter an ion manifold which directs ions into one or more mass analyzers (shown in FIG. 1 as ion trap mass analyzers). Stacked DC lens guide the ions into a quadrupole of the ion manifold that operates as an ion guide. The quadrupole assembly is rotated along its center axis by 90 degrees such that it is substantially orthoganol to the long quadrupole. Ions entering the quadrupole device can travel along the center axis in a “pass-through mode” (zero degrees of deflection) or the quadrupole and the stacked lens voltages are manipulated to deflect the ion beam at any angle between pass-through mode and 90 degrees. This deflection is rapidly switchable and allows ions to be directed to a selection of a plurality of manifold outlets leading to the mass analyzers.

FIG. 2 shows further details of the example ion manifold used in the example mass spectrometer if FIG. 1. For example, FIG. 2 shows a voltage scheme applied to the quadrupole assembly and the stacked DC lens to deflect the ion beam by 90 degrees. To deflect the ion beam into ion trap 1, device B is lowered in voltage relative to rods 1, 2, 3, 4, and devices A and C. The voltage gradient will deflect ions into ion trap 1. Once the ion trap is closed to start a scan, a new voltage scheme is applied, where a voltage offset is applied to device C such that device C is lower in voltage than devices A, B, and rods 1-4. This scheme will divert ions into ion trap 2. The scheme is expandable to include a plurality of traps or mass analyzers.

### Example 2: Multi-port Ion Manifold for Parallel Scanning of Numerous Mass Analyzers

FIG. 3 shows an example geometry of an ion manifold with an array of manifold outlets used to accomplish the same deflection described in Example 1, but with a more compact device. The ion manifold of FIG. 3 can utilize micro-electrodes printed on a PCB substrate and can be scaled to an arbitrary number of manifold outlets/mass analyzers. Each electrode can apply a DC and RF voltage to route ions into a network of ion trap mass analyzers. The device may include a second PCB substrate (not shown) stacked above the first PCB substrate, such that ions traverse the spacing between the substrates.

### Example 3: Proteomic Measurements Using Zero Dead-Time Tandem Mass Spectrometry Using a Multiport Ion Manifold

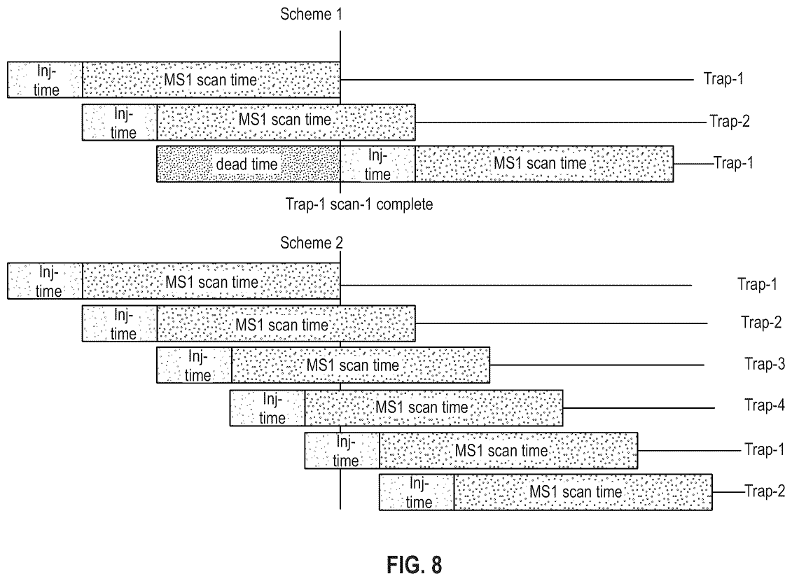

FIG. 8 shows an example timing sequence for injecting and analyzing ions such that the parallel utility of a mass spectrometer comprising multiple mass analyzers is leveraged to improve the tandem mass spec duty cycle. The mass range, which contains peptides, is divided into small windows in a DIA mode where each window is 10 amu wide; ions in each window are injected into each ion trap for analysis. The ion manifold can convert the ions in each isolation window to the number of elementary charges. The number of elementary charges injected into each ion trap mass analyzer can be regulated to avoid space charge repulsion and optimize transmission of the total ion flux into a plurality of ion trap mass analyzers.

Even with a small DIA isolation window of 10 amu the ion flux in the isolation window can be high enough to breach the upper limit of one million charges. Overfilling of the ion trap is avoided by implementing an Automated Gain Control (AGC) which regulates the ion injection time (IT) to control the total number of charges deposited into the ion trap. Scheme 1 shows an example where the IT is shorter than the time required for an ion trap mass analyzer to scan the range m/z 400 to m/z 900. Once ion injection in trap-1 is complete or when trap-1 starts a scan, the ion beam is deflected to build an AGC target for injecting ions into trap-2. However, when trap-2 starts a scan, the ion trap-1 is still scanning, and the ion beam is deflected to waste. This period is called dead time when the mass analyzer is “blind” to the incoming ion beam. Peptide ions arriving in the dead period are not recorded in an MS1 or MS2 and are never sequenced. Scheme 1 shows an example where more than two ion traps can improve the duty cycle such that the dead time is reduced or negligible. The latter scenario is addressed in scheme two, where four ion trap mass analyzers are networked in this example to use the ion beam continuously. At the end of each MS1 scan, the ion beam is deflected into the injection device of the next available ion trap. In this example, ion trap 1 is available for analysis at the end of ion trap four, thus eliminating the need for a fifth ion trap mass analyzer.

### Example 4: Computational Multiphysics Simulations of Example Ion Manifold Configurations

A commercial computational multiphysics simulation package was used to construct two example geometries of ion manifolds to demonstrate the feasibility of directing an ion flux to a selected outlet. Geometries tested included the cut-out to extract ions (e.g., r=0.25 mm to 1.0 mm). The angle used was 90 degrees to 22.5 degrees. Each rod was 4 mm square. The distance between each rod in the quadrupole arrangement was 5 mm.

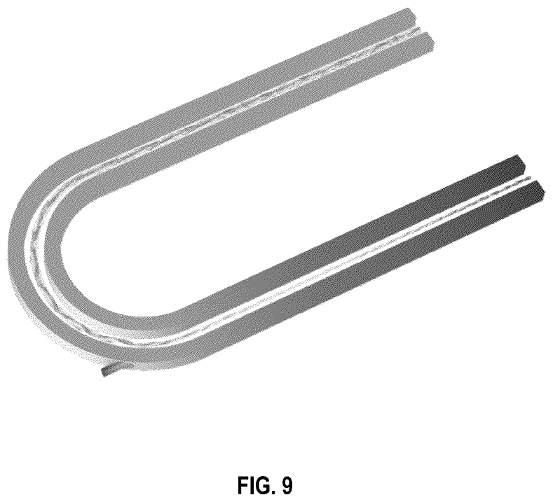

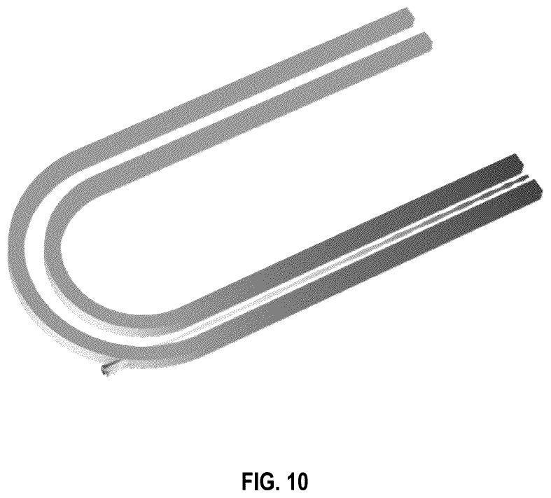

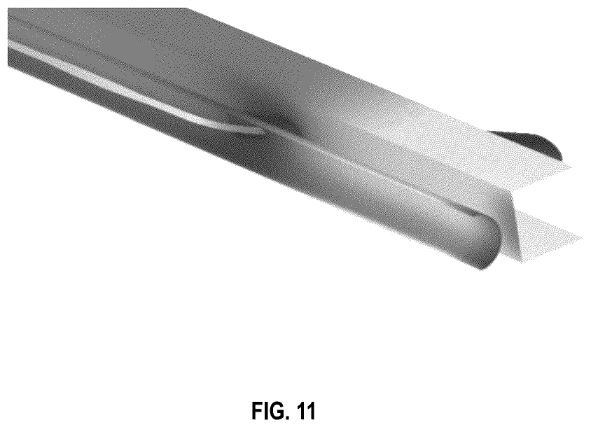

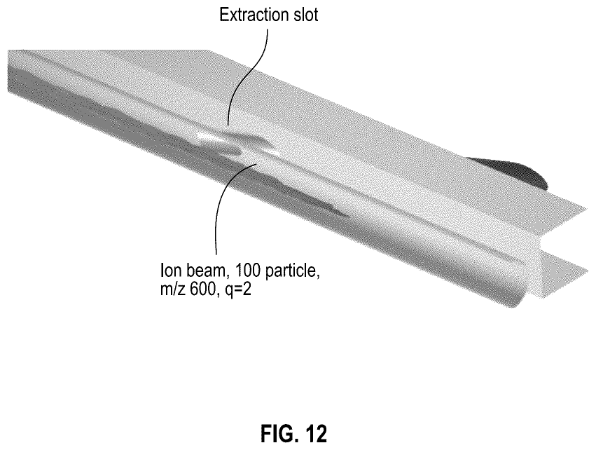

Results for the first geometry (similar to that detailed in FIG. 7) are shown in FIGS. 9-10. Results for the second geometry (similar to that detailed in FIG. 6) are shown in FIGS. 11-12. Images shown have additional features of the manifold clipped for clarity. As seen demonstrated in the figures the simulations showed that an ion flux in the ion manifold can be selectively directed either to an extraction outlet (see FIGS. 10-11) or can be directed to stay in the manifold or pass through to an alternate selected outlet at the opposite end of the quadrupole of the manifold (see FIGS. 9, 12).

### Example 5 Ion Mobility TOF Mass Spectrometer for Proteomic Analysis

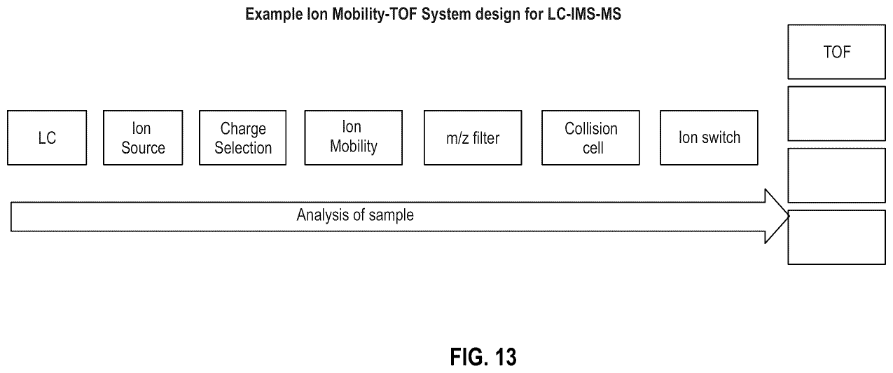

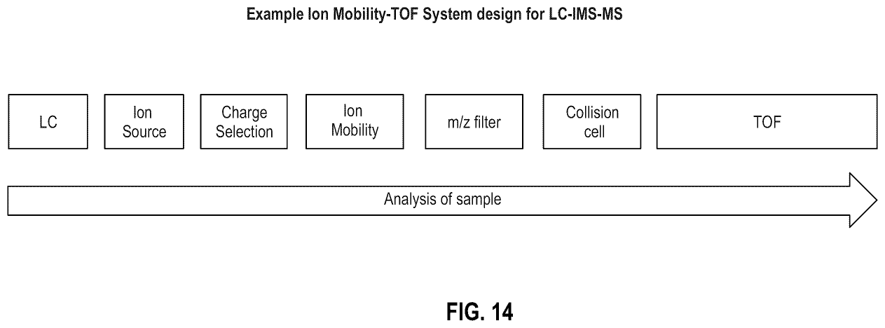

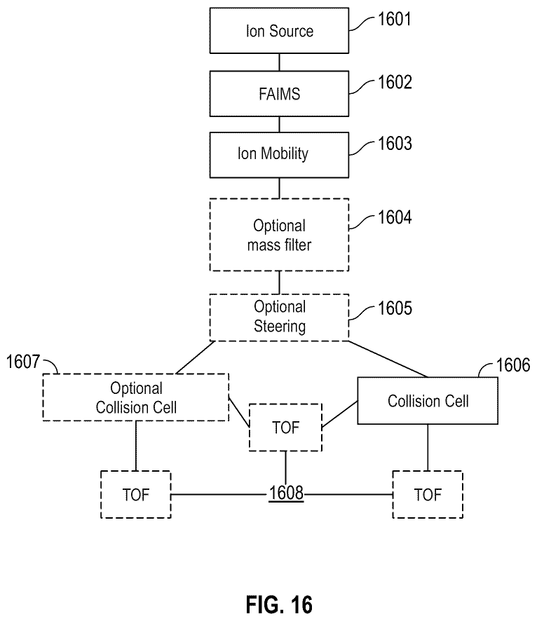

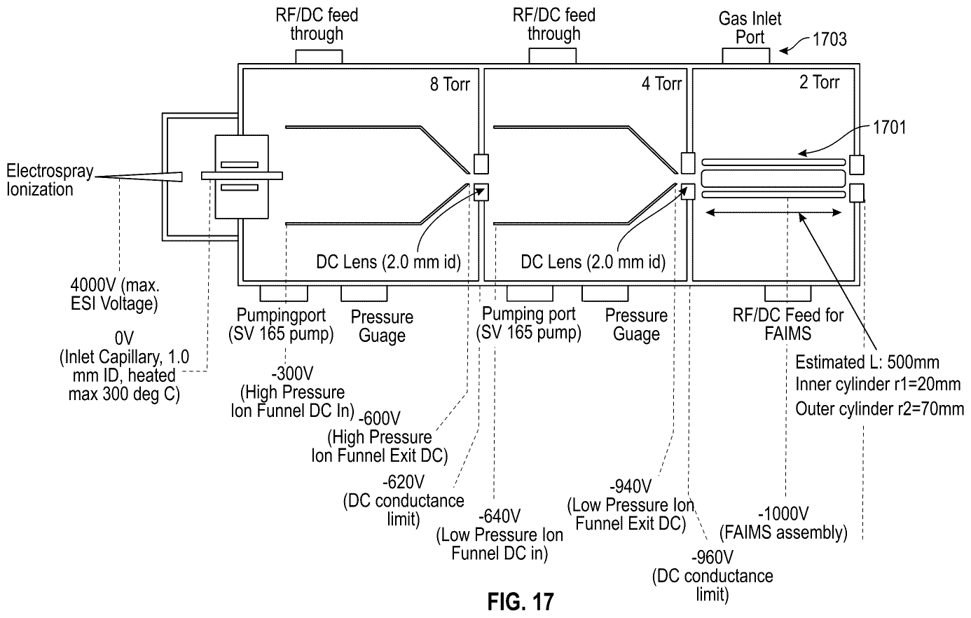

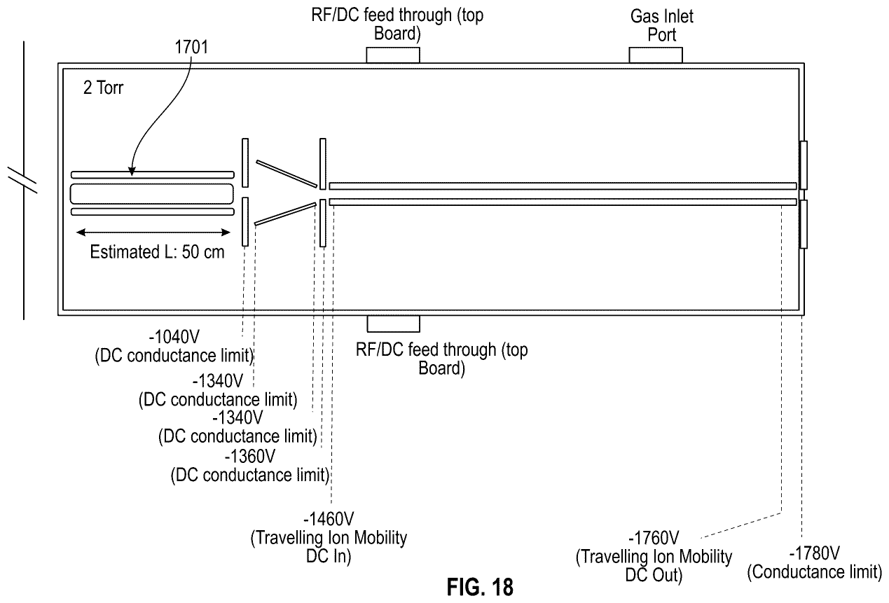

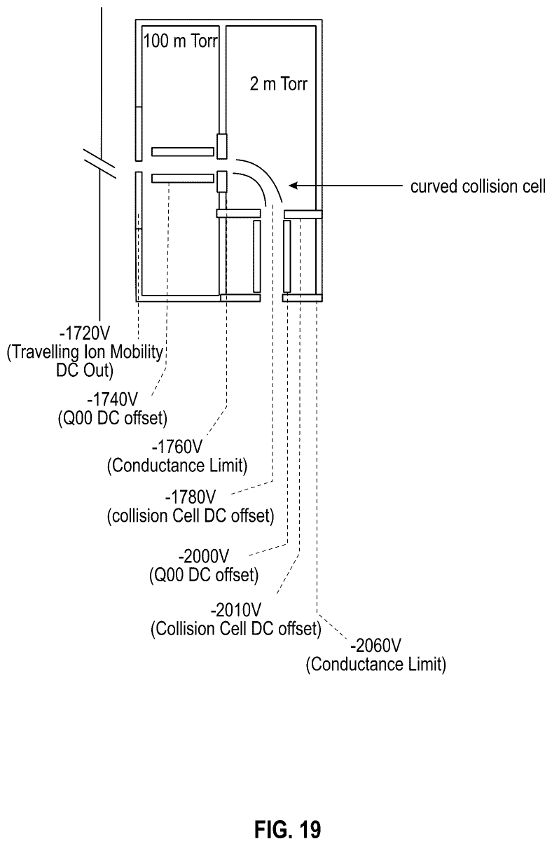

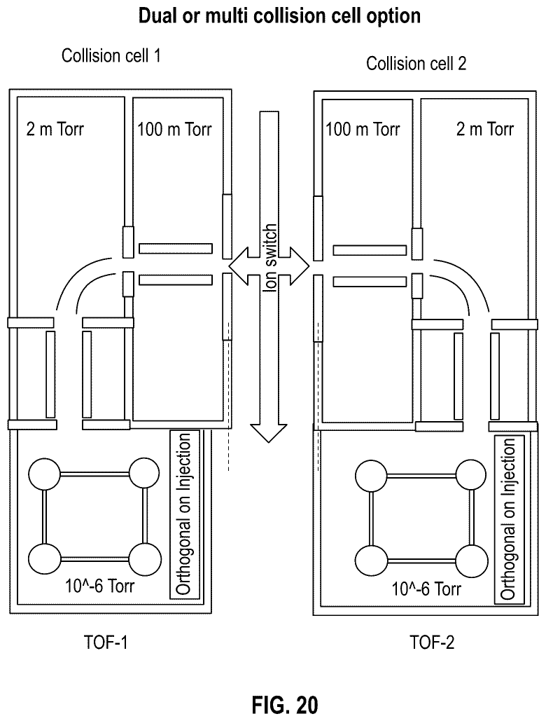

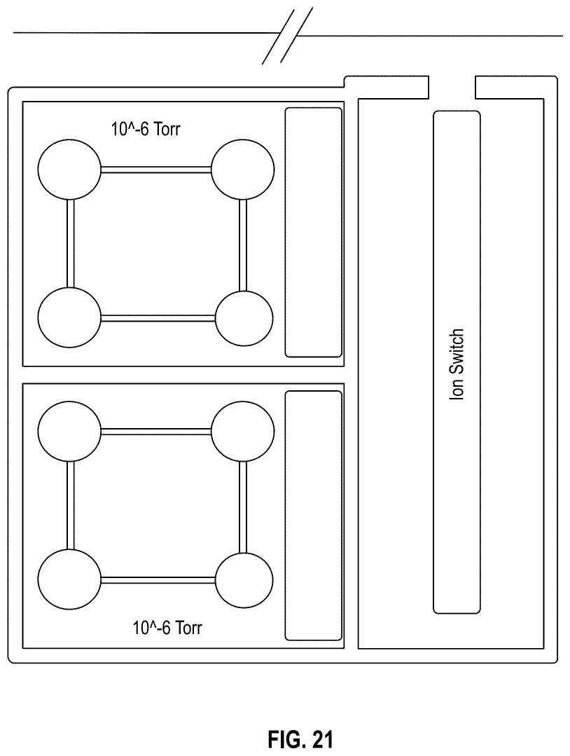

A proteomic sample is ionized using a nanoelectrospray emitter and analyzed using a workflow such as those shown in any of FIGS. 13-14, and 16. Ion flux from the emitter is introduced into a mass spectrometer (such as the example mass spectrometer shown in FIG. 17) comprising a reduced pressure FAIMS device (such as the device shown in FIG. 17) coupled with a TWIMS device (such as the device shown in FIG. 18). The FAIMS device removes singly charged ions from the ion flux and passes multiply charged analyte ions to the TWIMS device. The TWIMS device separates ions by time prior to introduction to one or more collision cells (such as the curved collision cells shown in FIG. 19 or 20) in order to maximize the duty cycle that each mass analyzer is detecting analyte ions. When utilizing more than one collision cell (and/or more than one mass analyzer) an ion switch (such an ion manifold described herein or a mechanical device that physically diverts ion guides) is used to select between collision cells (and/or mass analyzers), for example, as depicted in FIG. 20. Each collision cell is configured to pass ions in the m/z 400 to 900 range to further increase analyte ion flux at the detector. Configuration can be accomplished, for example, using a control computing system and a series of power supplies, such as depicted in FIG. 21. Each mass analyzer is also configured for analysis in this range.

While the location of the ion switch (such as an ion manifold described herein or a mechanical device that physically diverts ion guides) in FIG. 13 is depicted between the collision cell and four TOFs, other locations are possible. For example, the ion switch may be between the m/z filter (mass filter) and the collision cell. There may be two or more collision cells to match the number mass analyzer. As another example, the ion switch is between the m/z filter (mass filter) and the ion mobility device (e.g. a TWIMs device). The ion switch may be positioned anywhere between the ion source and mass analyzers. In some cases, the components after the ion switch are duplicated consistent with the number of mass analyzers.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the present disclosure may be employed in practicing the present disclosure. It is intended that the following claims define the scope of the present disclosure and that methods and structures within the scope of these claims and their equivalents be covered thereby. The section headings used herein are for organizational purposes only and are not to be construed as limiting the subject matter described.

What is claimed is:

1. A mass spectrometer, comprising:
a vacuum system;
an ion inlet, operably coupled to the vacuum system;
a first set of ion optics arranged within the vacuum system and configured to guide ions from the ion inlet toward an ion manifold within the vacuum system, the ion manifold comprising:
an ion manifold inlet;
a plurality of ion manifold outlets; and
at least one ion outlet selector; and
a second set of ion optics arranged within the vacuum system to guide ions from at least two of the plurality of ion manifold outlets to at least two mass analyzers, the at least two mass analyzers being disposed within, or operably coupled to, the vacuum system, the second set of ion optics including at least two collision activated dissociation cells, each collision activated dissociation cell being disposed between a different one of the plurality of ion manifold outlets and a corresponding mass analyzer.

2. The mass spectrometer of claim 1, wherein the ion outlet selector comprises at least one quadrupole disposed between the ion manifold inlet and the plurality of ion manifold outlets and being configurable to guide ions toward a selected one of the plurality of ion manifold outlets.

3. The mass spectrometer of claim 1, wherein the ion outlet selector comprises a plurality of RF and/or DC ion guide lenses.

4. The mass spectrometer of claim 1, wherein the ion manifold directs the ion flux from the ion manifold inlet to two or more ion manifold outlets near simultaneously.

5. The mass spectrometer of claim 1, wherein the plurality of ion outlets comprises at least three ion manifold outlets.

6. The mass spectrometer of claim 5, wherein the at least two mass analyzers comprise at least three mass analyzers.

7. The mass spectrometer of claim 1, wherein each of the at least two mass analyzers is a time-of-flight mass analyzer.

8. The mass spectrometer of claim 1, wherein the first set of ion optics comprises a traveling wave ion mobility spectrometry device (TWIMS) or a trapped ion mobility spectrometry device (TIMS).

9. The mass spectrometer of claim 1, wherein each of the mass analyzers is configured to scan across an independently selected mass range during at least partially overlapping periods of time.

10. The mass spectrometer of claim 1, wherein each of the mass analyzers is configured to scan across an independently selected mass range at essentially the same time.

11. The mass spectrometer of claim 1, wherein the second set of ion optics comprises at least two quadrupole mass filters, each quadrupole mass filter disposed between a different one of the at least one or more of the ion manifold outlets and a corresponding collision activated dissociation cell.

12. The mass spectrometer of claim 1, wherein each of the plurality of ion manifold outlets is selectively gated to stop or pass the ion flux using a set of stacked DC lenses corresponding to the individual ion manifold outlet.

13. A method of acquiring mass spectra of a sample, the method comprising:
ionizing the sample using an ion source to produce gas-phase ions;
introducing the gas-phase ions into a mass spectrometer, the mass spectrometer comprising:
a vacuum system;
an ion inlet, operably coupled to the vacuum system;
a first set of ion optics arranged within the vacuum system and configured to guide ions from the ion inlet toward an ion manifold within the vacuum system, the ion manifold comprising:
an ion manifold inlet;
a plurality of ion manifold outlets; and
at least one ion outlet selector; and
a second set of ion optics arranged within the vacuum system to guide ions from at least two of the plurality of ion manifold outlets to at least two mass analyzers, the at least two mass analyzers being disposed within, or operably coupled to, the vacuum system, the second set of ion optics further including at least first and second collision activated dissociation cells;
selecting a first mass isolation window of a first one of the at least two mass analyzers corresponding to a first one of the plurality of ion manifold outlets and fragmenting the mass-isolated ions to generate first product ions;
selecting a second mass isolation window of a second one of the at least two mass analyzers corresponding to a second one of the plurality of ion manifold outlets and fragmenting the mass-selected ions to generate second product ions; and
acquiring mass spectra of both the first and second product ions using the at least two mass analyzers.

14. The method of claim 13, further comprising:
selecting a third mass isolation window of a third one of the at least two mass analyzers corresponding to a third one of the plurality of ion manifold outlets and fragmenting the mass-selected ions to generate third product ions; and
acquiring mass spectra of the first, second, and third product ions using the at least two mass analyzers.

15. The method of claim 14, further comprising:
selecting a fourth mass isolation window of a fourth one of the at least two mass analyzers corresponding to a fourth one of the plurality of ion manifold outlets and fragmenting the mass-selected ions to generate fourth product ions; and
acquiring mass spectra of the first, second, third, and fourth product ions using the at least two mass analyzers.

16. The method of claim 13, wherein the first and second mass isolation windows each have widths less than about 6 amu.

17. The method of claim 17, further comprising a step of separating ions according to their mobilities using a traveling wave ion mobility spectrometry device (TWIMS) or a trapped ion mobility spectrometry device (TIMS).

18. The method of claim 18, wherein the TWIMS or TIMS device is located upstream in the ion path of the at least one ion selector.

19. The method of claim 13, wherein the at least two mass analyzers each comprise a time-of-flight mass analyzer.

20. The method of claim 13, wherein each of the mass analyzers is configured to scan across an independently selected mass range during at least partially overlapping periods of time.

21. The method of claim 13, wherein each of the mass analyzers is configured to scan across an independently selected mass range at essentially the same time.
